(19) United States
(12) Patent Application Publication
(10) Pub. No.: US 2022/0333757 A1
(43) Pub. Date: Oct. 20, 2022

(54) HYBRID LED/LASER LIGHT SOURCE FOR SMART HEADLIGHT APPLICATIONS

(71) Applicant: Optonomous Technologies, Inc., Agoura Hills, CA (US)

(72) Inventors: Kenneth Li, Agoura Hills, CA (US); Yung Peng Chang, Hsinchu (TW)

(21) Appl. No.: 17/620,109

(22) PCT Filed: Jun. 14, 2020
(86) PCT No.: PCT/US20/37669

§ 371 Date: Dec. 16, 2021

Related U.S. Application Data
(60) Provisional application No. 62/862,549, filed on Jun. 17, 2019.
(60) Provisional application No. 62/874,943, filed on Jul. 16, 2019.
(60) Provisional application No. 62/938,863, filed on Nov. 21, 2019.
(60) Provisional application No. 62/954,337, filed on Dec. 27, 2019.

(51) Int. Cl. F21S 41/675; F21S 41/147; F21S 41/25; F21S 41/176; F21S 45/47; F21S 41/16

(52) U.S. Cl. CPC F21S 41/675; F21S 41/147; F21S 41/25; F21S 41/176; F21S 45/47; F21S 41/16

(57) ABSTRACT

Apparatus including a hybrid light source for smart automotive-headlight applications. The hybrid light source includes: an LED light source of full-area illumination; a laser-pumped phosphor material that provides hot-spot illumination; a DMD having plurality of micromirrors coupled to receive light from the full-area illumination and the hot-spot illumination, wherein each micromirror selectively reflects light in one of a plurality of directions; and projection optics that receives light selectively reflected by the micromirrors and is configured to project the received light as a beam having a shaped illumination-intensity pattern. Another aspect includes an assembly including a heatsink; an LED on the heatsink that emits LED pump light; a first phosphor layer on the LED that absorbs LED pump light and outputs a full-area illumination having wavelength-converted light and an unconverted portion of LED pump light; and a laser-pumped second phosphor layer coupled to output wavelength-converted and laser light as hot-spot illumination.

### CROSS-REFERENCE TO RELATED APPLICATIONS

This application claims priority benefit, including under 35 U.S.C. § 119(e), of

U.S. Provisional Patent Application 62/862,549 titled “ENHANCEMENT OF LED INTENSITY PROFILE USING LASER EXCITATION,” filed Jun. 17, 2019, by Kenneth Li;

U.S. Provisional Patent Application 62/874,943 titled “ENHANCEMENT OF LED INTENSITY PROFILE USING LASER EXCITATION,” filed Jul. 16, 2019, by Kenneth Li;

U.S. Provisional Patent Application 62/938,863 titled “DUAL LIGHT SOURCE FOR SMART HEADLIGHT APPLICATIONS,” filed Nov. 21, 2019, by Y. P. Chang et al.; and

U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;

each of which is incorporated herein by reference in its entirety.

This application is related to:

P.C.T. Patent Application No. PCT/US2020/034447, filed May 24, 2020 by Y. P. Chang et al., titled “LiDAR INTEGRATED WITH SMART HEADLIGHT AND METHOD,”

U.S. Provisional Patent Application No. 62/853,538, filed May 28, 2019 by Y. P. Chang et al., titled “LIDAR Integrated With Smart Headlight Using a Single DMD,”

U.S. Provisional Patent Application No. 62/857,662, filed Jun. 5, 2019 by Chun-Nien Liu et al., titled “Scheme of LIDAR-Embedded Smart Laser Headlight for Autonomous Driving,” and

U.S. Provisional Patent Application No. 62/950,080, filed Dec. 18, 2019 by Kenneth Li, titled “Integrated LIDAR and Smart Headlight using a Single MEMS Mirror,”

PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);

U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);

U.S. patent application Ser. No. 16/509,196 titled “ILLUMINATION SYSTEM WITH HIGH INTENSITY PROJECTION MECHANISM AND METHOD OF OPERATION THEREOF,” filed Jul. 11, 2019, by Y. P. Chang et al. (published Jan. 23, 2020 as US 2020/0026170);

U.S. Provisional Patent Application 62/837,077 titled “LASER EXCITED CRYSTAL PHOSPHOR SPHERE LIGHT SOURCE,” filed Apr. 22, 2019, by Kenneth Li et al.;

U.S. Provisional Patent Application 62/853,538 titled “LIDAR INTEGRATED WITH SMART HEADLIGHT USING A SINGLE DMD,” filed May 28, 2019, by Y. P. Chang et al.;

U.S. Provisional Patent Application 62/856,518 titled “VERTICAL CAVITY SURFACE EMITTING LASER USING DICHROIC REFLECTORS,” filed Jul. 8, 2019, by Kenneth Li et al.;

U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;

U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;

U.S. Provisional Patent Application 62/873,171 titled “SPECKLE REDUCTION USING MOVING MIRRORS AND RETRO-REFLECTORS,” filed Jul. 11, 2019, by Kenneth Li;

U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;

U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;

U.S. Provisional Patent Application 62/903,620 titled “RGB LASER LIGHT SOURCE FOR PROJECTION DISPLAYS,” filed Sep. 20, 2019, by Lion Wang et al.; and

PCT Patent Application No. PCT/US2020/035492, filed Jun. 1, 2020 by Kenneth Li et al., titled “VERTICAL-CAVITY SURFACE-EMITTING LASER USING DICHROIC REFLECTORS”;

each of which is incorporated herein by reference in its entirety.

### FIELD OF THE INVENTION

This invention relates to the field of lasers, light-emitting diodes (LEDs), and light sources, and more specifically to a method and hybrid light source that includes LED and laser-pumped phosphor light sources combined together to provide light-intensity profiles suitable for various headlight-illumination ranges, wherein, in some embodiments, the light is projected using, e.g., a multiple-mirror DMD (digital micromirror device) with various projected patterns, for increased safety.

### BACKGROUND OF THE INVENTION

Road safety has become an important subject to be addressed by automotive lighting, including projection of symbols, dimming headlights in response to the approach of oncoming vehicles, increased output for pedestrians, and other safety purposes. All these functions can be done using active imagers, such that the desired or required light pattern can be projected. One major obstacle is the differing brightness requirements of low-beam, high-beam, and extreme-high-beam automotive headlighting. At this time, there is no single light source that can achieve such multiple requirements using a single imager chip, such as a Texas Instruments' DLP® DMD. As a result, many new automobiles are designed with multiple headlights, one for low beam, one for high beam, and one for extreme high beam. Having three or more headlights on left and right sides is not uncommon, and may be found in many new automobiles, such as those shown in car shows. On the other hand, automobile designers often do not like to see headlights, as they disturb the “profiles” and the “look” of automobiles. As a result, there have been movable headlight covers in the past, to cover the large headlights. Recent headlight designs are targeted for very low and extremely low profiles. Total height in the range of 10 mm has been shown and designed. Such designs, however, still require multiple headlights to provide the various ranges of illumination mentioned above.

U.S. Pat. No. 4,520,116 issued to Gentilman et al. on May 28, 1985 with the title “Transparent aluminum oxynitride and method of manufacture” and is incorporated herein by reference. U.S. Pat. No. 4,520,116 describes a polycrystalline cubic aluminum oxynitride having a density of at least 98% of theoretical density, and being transparent to electromagnetic radiation in the wavelength range from 0.3 to 5 micrometers with an in-line transmission of at least 20% in this range. A method of preparing the optically transparent aluminum oxynitride is also provided including the steps of forming a green body of substantially homogeneous aluminum oxynitride powder and pressureless sintering said green body in a nitrogen atmosphere and in the presence of predetermined additives which enhance the sintering process. Preferred additives are boron and yttrium in elemental or compound form.

U.S. Pat. No. 4,686,070 issued to Maguire, et al. on Aug. 11, 1987 with the title “Method of producing aluminum oxynitride having improved optical characteristics” and is incorporated herein by reference. U.S. Pat. No. 4,686,070 describes a method of preparing substantially homogeneous aluminum oxynitride powder that includes the steps of reacting gamma aluminum oxide with carbon in the presence of nitrogen, and breaking down the resulting powder into particles in a predetermined size range. A method of preparing a durable optically transparent body from this powder is also provided that includes the steps of forming a green body of substantially homogeneous cubic aluminum oxynitride powder and sintering said green body in a nitrogen atmosphere and in the presence of predetermined additives which enhance the sintering process. Preferred additives are boron, in elemental or compound form, and at least one additional element selected from the group of yttrium and lanthanum or compounds thereof. The sintered polycrystalline cubic aluminum oxynitride has a density greater than 99% of theoretical density, an in-line transmission of at least 50% in the 0.3- to 5-micron range, and a resolving angle of 1 mrad or less.

There remains a need in the art for methods and apparatus to better control the brightness of automotive headlight beams, and to provide the ability to dynamically reshape various portions of such vehicle headlight beams.

### SUMMARY OF THE INVENTION

In some embodiments, the present invention provides a hybrid light source with LED and laser-pumped-phosphor elements combined together to provide light-intensity profiles for various ranges required in automotive driving, with the output beam projected using a single digital micromirror device (DMD), with the ability to project patterns, for increased safety.

### BRIEF DESCRIPTION OF THE DRAWINGS

FIG. 1 is a side-cross-sectional-view block diagram of a hybrid LED/laser-pumped-phosphor light source 101 with heat sink 111 for smart headlight applications, according to some embodiments of the present invention.

FIG. 2A is a side-cross-sectional-view block diagram of LED assembly 201 of a phosphor plate 212 that is in contact with a blue LED 222 such that phosphor plate 212 is back-side pumped by LED 222 and selectively front-side pumped by a laser beam 241 to form a hot spot 242 (see FIG. 2D), according to some embodiments of the present invention.

FIG. 2B is a side-cross-sectional-view block diagram of LED assembly 202 that includes a phosphor plate 216 that is separated from a blue LED 222 such that phosphor plate 216 is back-side pumped by LED 222 and front-side pumped by a laser beam 241 to form a hot spot 242 (see FIG. 2D), according to some embodiments of the present invention.

FIG. 2C is a front-view diagram of light-intensity profile 203, according to some embodiments of the present invention.

FIG. 2D is a front-view diagram of light-intensity profile 204, according to some embodiments of the present invention.

FIG. 3 is a side-cross-sectional-view block diagram of a hybrid LED/laser-pumped-phosphor light source 301 with heat-sink enclosure 315 for smart headlight applications, according to some embodiments of the present invention.

FIG. 4 is a side-cross-sectional-view block diagram of a hybrid LED/laser-pumped-phosphor light source 401, according to some embodiments of the present invention.

FIG. 5 is a side-cross-sectional-view block diagram of a hybrid LED/laser-pumped-phosphor light source 501, according to some embodiments of the present invention.

FIG. 6 is a side-cross-sectional-view block diagram of a side-emitting hybrid LED/laser-pumped-phosphor light source 601, according to some embodiments of the present invention.

FIG. 7 is a side-cross-sectional-view block diagram of a hybrid LED/laser-pumped-phosphor light source 701, according to some embodiments of the present invention.

FIG. 8A1 is a side-cross-sectional-view block diagram of an LED/laser-pumped-phosphor light source assembly 801, according to some embodiments of the present invention.

FIG. 8A2 is a plan-view block diagram of LED/laser-pumped-phosphor light source assembly 801.

FIG. 8B1 is a side-cross-sectional-view block diagram of an LED/laser-pumped-phosphor light source assembly 802, according to some embodiments of the present invention.

FIG. 8B2 is a plan-view block diagram of LED/laser-pumped-phosphor light source assembly 802.

FIG. 8C1 is a side-cross-sectional-view block diagram of an LED/laser-pumped-phosphor light source assembly 803, according to some embodiments of the present invention.

FIG. 8C2 is a plan-view block diagram of LED/laser-pumped-phosphor light source assembly 803.

FIG. 8D1 is a side-cross-sectional-view block diagram of an LED/laser-pumped-phosphor light source assembly 804, according to some embodiments of the present invention.

FIG. 8D2 is a plan-view block diagram of LED/laser-pumped-phosphor light source assembly 804.

FIG. 8E1 is a side-cross-sectional-view block diagram of an LED/laser-pumped-phosphor light source assembly 805, according to some embodiments of the present invention.

FIG. 8E2 is a plan-view block diagram of LED/laser-pumped-phosphor light source assembly 805.

FIG. 8F is a schematic front-view block diagram of a light-emitting structure 806 having three white LED emitters 861, 862, and 863 and a reflective-phosphor plate 860, according to some embodiments of the present invention

FIG. 8G is a plan-view block diagram of an illumination pattern 807 as projected onto a DMD 940, according to some embodiments of the present invention.

FIG. 9 is a schematic block diagram of a projected illumination pattern 901 of an automotive headlight, according to some embodiments of the present invention.

FIG. 10A is a front-view block diagram of a commercial LED 1001 with a rectangular emitting area 1012 wherein LED assembly 1001 includes four rectangular LEDs placed side by side, which is used in some embodiments of the present invention.

FIG. 10B is a first side-cross-sectional-view block diagram of LED 1001.

FIG. 10C is a second side-cross-sectional-view block diagram of LED 1001.

FIG. 11A is a front-view and side-cross-sectional-view and back-view block diagrams of another commercial LED assembly 1101 with a long rectangular emitting area 1112, wherein LED assembly 1101 includes five rectangular LEDs, which is used in some embodiments of the present invention.

FIG. 11B is a side-cross-sectional-view block diagram of LED 1101.

FIG. 11C is a back-view block diagram of LED 1101.

FIG. 12 is a side-cross-sectional-view block diagram of a hybrid LED/laser-pumped-phosphor light source 1201 for smart headlight applications, according to some embodiments of the present invention.

FIG. 13 is a side-cross-sectional-view block diagram of a hybrid LED/laser-pumped-phosphor light source 1301 for smart headlight applications, according to some embodiments of the present invention.

FIG. 14 is a side-view cross-section block diagram of a laser-pumped-phosphor light source 1401.

FIG. 15A is a side-view cross-sectional block diagram of another hybrid LED/laser-pumped-phosphor light source 1501, according to some embodiments of the present invention.

FIG. 15B is a top-view block diagram of hybrid LED/laser-pumped-phosphor light source 1501.

FIG. 16 is a top-cross-sectional-view block diagram of a DMD-based hybrid LED/laser-pumped-phosphor light source 1601, according to some embodiments of the present invention.

FIG. 17 is a block diagram of a vehicle 1701 that includes a LED/laser-pumped-phosphor light source 1711, according to some embodiments of the present invention.

### DETAILED DESCRIPTION OF PREFERRED EMBODIMENTS OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In smart automotive headlight applications, in order to provide a wide field of view (FOV) while maintaining high on-center brightness, the illumination source luminance for the on-center portion of the FOV must increase in proportion to the relative FOV area increase. Otherwise, the hot-spot brightness will fall in inverse proportion to the area increase of the total FOV covered by the digital micromirror device (DMD). Effectively, the area dilution of the brightness from increasing the FOV must be counteracted by an increase in source luminance (for the center hot-spot section only). For example, if only 1% of the total area at the center needs to have a higher brightness, without a hot spot it would require the whole area to have a higher brightness, increasing the total output power, making it difficult or impossible to implement (within commercialization constraints such as size, heat-dissipation capability and/or cost). This invention discloses an optical configuration in which the center portion of the LED is pumped using a laser such that a hot spot is formed in the center section of the output illumination, with a sharp roll-off to a relatively lower luminance in outer sections of the LED output illumination.

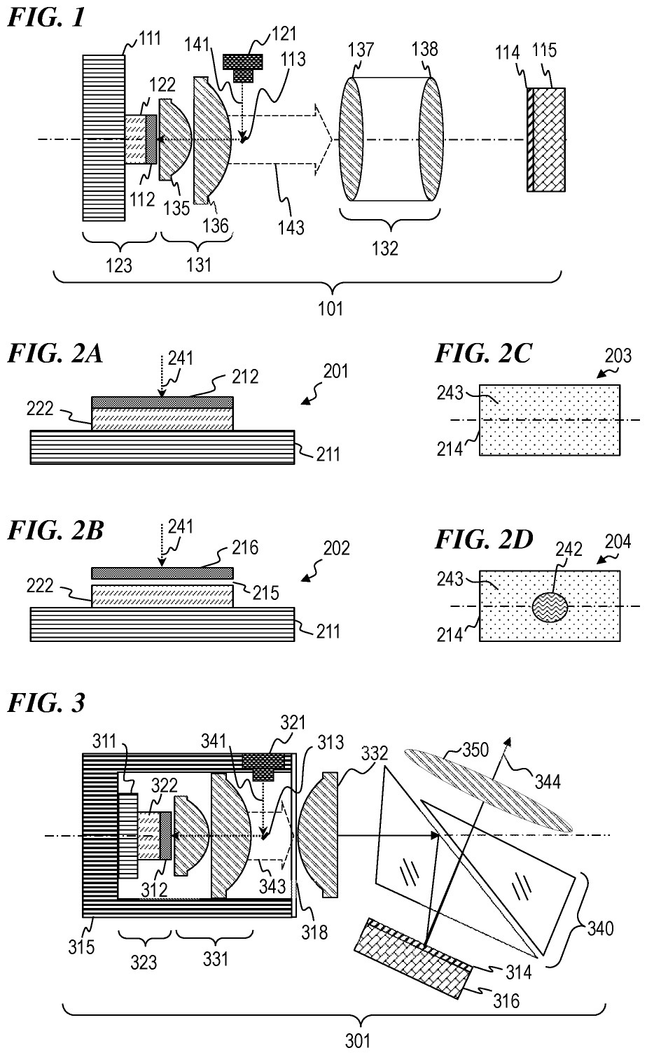

FIG. 1 is a side-cross-sectional-view block diagram of a hybrid LED/laser-pumped-phosphor light source 101 with heat sink 111 for smart-headlight applications, according to some embodiments of the present invention. In some embodiments, hybrid LED/laser-pumped-phosphor light source 101 includes an LED assembly 123 that is used for headlight illumination, wherein laser beam 141, after reflecting from mirror 113, impinges on a center area of the phosphor layer 112 to provide increased light intensity in that one center area of the phosphor layer 112 such that the output intensity profile is not uniform, but now includes a “hot spot” (an area of higher light output intensity) within the illuminated area. In some embodiments, laser beam 141 from laser 121 is reflected by reflector 113 and is used to additionally pump the center portion of the phosphor of the LED assembly 123, producing the hot spot. In some embodiments, LED assembly 123 includes an LED 122 (e.g., in some embodiments, an LED that emits light of a blue color with a center wavelength in the range of about 420 nm to about 490 nm) mounted to a heatsink 111 that conducts heat away from LED 122 and dissipates that heat to the local environment. In some embodiments, LED 122 is covered by a phosphor layer 112 that absorbs some of the light of the LED 122 and re-emits light of a longer wavelength (e.g., in some embodiments, absorbing blue LED light in the range of about 420 nm to about 490 nm and re-emitting yellow light having a peak center wavelength in a range of about 560 nm to about 660 nm). The combination of some unconverted blue light and some light converted to yellow light produces a light that appears to the human eye as white light. Thus, LED assembly 123 can be considered as a white-light-emitting LED (also called a white LED assembly 123). In some embodiments, in order that mirror 113 is not blocking most of the hot-spot output light, mirror 113 is a dichroic reflector that preferentially reflects most blue light and preferentially transmits most light of other wavelengths (such as yellow light re-emitted by phosphor layer 112). In some embodiments, mirror 113 is off-center (in contrast to the embodiment shown in FIG. 1) and angled such that the reflected part of laser beam 141 impinges on the desired area of phosphor layer 112. In some embodiments, one or more lenses (e.g., lens 135 and lens 136) form collimating lens assembly 131 used to collimate the white-light wide beam 143 (which includes a portion of unconverted blue light from LED 122 and some LED-pumped yellow light and a portion of unconverted blue light from laser 121 and the laser-pumped yellow light from phosphor layer 112), and this combined light is projected using projection-lens assembly 132 onto a digital-mirror device (DMD) 114 that is mounted to heatsink 115. In some embodiments, pumping laser 121 includes a laser diode with a collimating lens such that the output laser beam 141 of the pumping laser 121 is a collimated parallel beam. In some embodiments, output light 143 (obtained from the laser-pumped and LED-pumped white LED assembly 123) is collimated using the collimating lenses 131 to become parallel. In some embodiments, both the broad-area light and the hot-spot light from LED assembly 123 have similar angular distribution, which is Lambertian. The broad-area light and the hot-spot light outputs of LED assembly 123 are collimated by collimating lens assembly 131, becoming the beam 143. In some embodiments, part of beam 143 is blocked by the mirror 113 (partially blocked if 113 is blue reflective and yellow transmissive). The light from the hot spot is part of the parallel beam 143. When projected, the image of the LED assembly 123 with its laser-pumped hot spot is projected onto the roadway. Light source 101 is a projection system in which the intensity profile of the LED with its hot spot is projected as a single beam. In some embodiments, located near the output of the collimating lens assembly 131 where the beam 143 is collimated and parallel, small mirror 113, covering a small portion of the parallel output beam 143 but larger than input laser beam 141, is used to reflect the blue laser beam 141 towards the white LED assembly 123. The parallel laser beam 141 reflected by mirror 113 is focused by the collimating lens assembly 131, providing additional pumping to the phosphor layer 112 selectively (both in space and in time). This selective pumping, e.g., in some embodiments, at the center portion of the LED's phosphor 112, provides a hot spot on the phosphor 112 and the output is coupled to the DMD 114 using the coupling lens assembly 132.

In some embodiments, phosphor layer 112 is in direct contact with LED 122 such as shown in phosphor layer 212 and LED 222 of FIG. 2A, while in other embodiments, phosphor layer 112 is separated slightly from LED 122 by a small gap, such as shown in phosphor layer 216 and LED 222 of FIG. 2B.

FIG. 2A is a side-cross-sectional-view block diagram of LED assembly 201 that includes a phosphor plate 212 that is in contact with a blue LED 222 such that phosphor plate 212 is back-side pumped by LED 222 and selectively front-side pumped by a laser beam 241, according to some embodiments of the present invention. In some embodiments, LED assembly 201 is used for white-LED assembly 123. In some embodiments, LED assembly 201 includes a blue LED 222 with its blue-color-light output pumping a phosphor layer 212 that is directly deposited on a surface of the blue LED 222. In other embodiments (not shown) phosphor layer 212 includes a glass, ceramic, or crystal phosphor plate placed on a surface of the blue LED 222 and held there with glue. In some embodiments, a laser beam 241 is used to pump a hot spot of increased brightness in a relatively small area (e.g., in some embodiments, near the center) of phosphor layer 212.

FIG. 2B is a side-cross-sectional-view block diagram 202 of a phosphor plate 216 that is separated from a blue LED 222 such that phosphor plate 216 is back-side pumped by LED 222 and front-side pumped by a laser beam 241 to form a hot spot 242 (see FIG. 2C, where there is no hot spot 242 as a consequence of LED being 222 on, but laser beam 241 being off, and FIG. 2D, where there is a hot spot 242 resulting from LED 222 being on and laser beam 241 also being on), according to some embodiments of the present invention. In some embodiments, the brightness of the laser beam is modulated by a control circuit, and thus the brightness of the hot spot is adjusted. In some embodiments, phosphor plate 216 is a glass, ceramic, or crystal-phosphor plate held at a small distance from LED 222 (by a structure not shown here) with a gap 215 between the LED 222 and the phosphor plate 216.

FIG. 2C is a front-view diagram of light-intensity profile 203 of an image 214 (i.e., the image of phosphor plate 112 as projected onto DMD 114 (see FIG. 1)) when phosphor plate 112 is back-side pumped by LED 122 (forming substantially uniform illumination 243 (corresponding to beam portion 143 of FIG. 1)) but not front-side pumped by a laser beam 241, according to some embodiments of the present invention.

FIG. 2D is a front-view diagram of light-intensity profile 204 of image 214 as projected onto DMD 114 (again see FIG. 1) when phosphor plate 216 is back-side pumped by LED 222 (forming substantially uniform illumination 243) and front-side pumped by a laser beam 241 forming a hot-spot illumination 242, according to some embodiments of the present invention.

In some embodiments, the light-intensity profile 203 or 204 on the DMD 114 with the selectively activatable hot spot 242 is then projected (using projection optics, not shown here in FIG. 1, FIG. 2C, and FIG. 2D) as a headlight beam toward the target roadway with a much higher intensity selectively applied at the center of the illuminated area, as shown in FIG. 2D versus FIG. 2C. This selectable hot spot is desirable for automotive smart-headlight applications, where the illumination for the low beam is close to the vehicle where lower intensity profile 243 will be sufficient. On the other hand, for the high beam where the illuminated area is further away, a higher intensity is required, but the beam angle is much smaller, and thus this can be illuminated by the selectably activated hot spot 242 on the DMD 114.

FIG. 3 is a side-cross-sectional-view block diagram of a hybrid LED/laser-pumped-phosphor light source 301 with enclosure 315 for smart-headlight applications, according to some embodiments of the present invention. In some embodiments, light source 301 includes an LED assembly 323 that includes an LED 322 (e.g., in some embodiments, an LED that emits light of a blue color with a center wavelength in the range of about 420 nm to about 490 nm) mounted to a heatsink 311 that conducts heat away from LED 322 and conducts that heat to enclosure 315 that provides additional external surface area to dissipate heat. In some embodiments, heatsink 311 and enclosure 315 are a single piece of metal or other thermally conductive material. In some embodiments, heatsink 311 is omitted and LED 322 is directly affixed to enclosure 315. In some embodiments, enclosure 315 includes a plurality of external fins (either as part of the enclosure structure or as a clip-on or other externally attached additional structure) to provide additional surface area to radiate or conduct heat to the local environment. In some embodiments, laser 321 is mounted to enclosure 315 in order that enclosure 315 also dissipates heat from laser 321. In some embodiments, small mirror 313 is oriented at a 45° angle to direct laser beam 341 toward a center of phosphor plate 312. The resulting overall light from LED assembly 323 is collimated by collimating lens assembly 331 to form beam 343 that is substantially parallel white light (which includes unconverted blue light from LED 322 and wavelength-converted yellow light from phosphor plate 312 pumped by light from LED 322, as well as a portion of unconverted blue light from laser 321 and wavelength-converted yellow hot-spot light from the portion of phosphor plate 312 pumped by light 341 from laser 321). In some embodiments, both the broad-area light and the hot-spot light from LED assembly 323 have similar angular distribution, which is Lambertian. In some embodiments, planar transparent window 318 seals the light-exit end of enclosure 315. In some embodiments, coupling lens 332 images beam 343 through total-internal-reflection (TIR) prism assembly 340 onto DMD 314 that is mounted on heatsink 316. In some embodiments, TIR-prism assembly 340 transmits substantially all light that impinges a surface at an angle at or close to the surface normal angle, but reflects substantially all light that impinges an internal surface at an angle further from the surface normal angle.

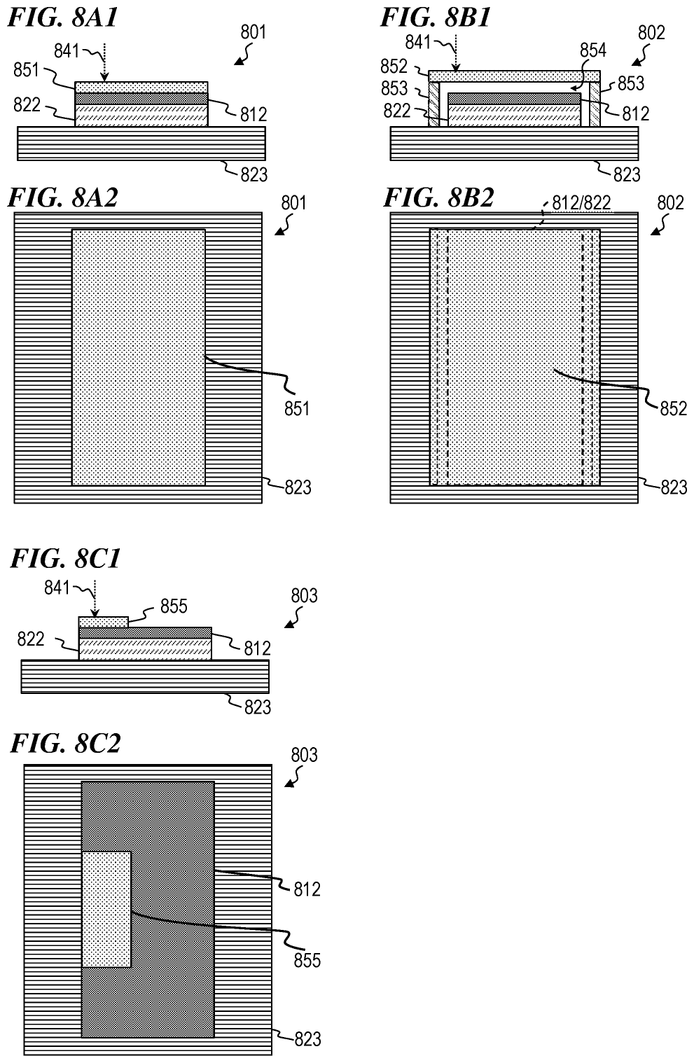

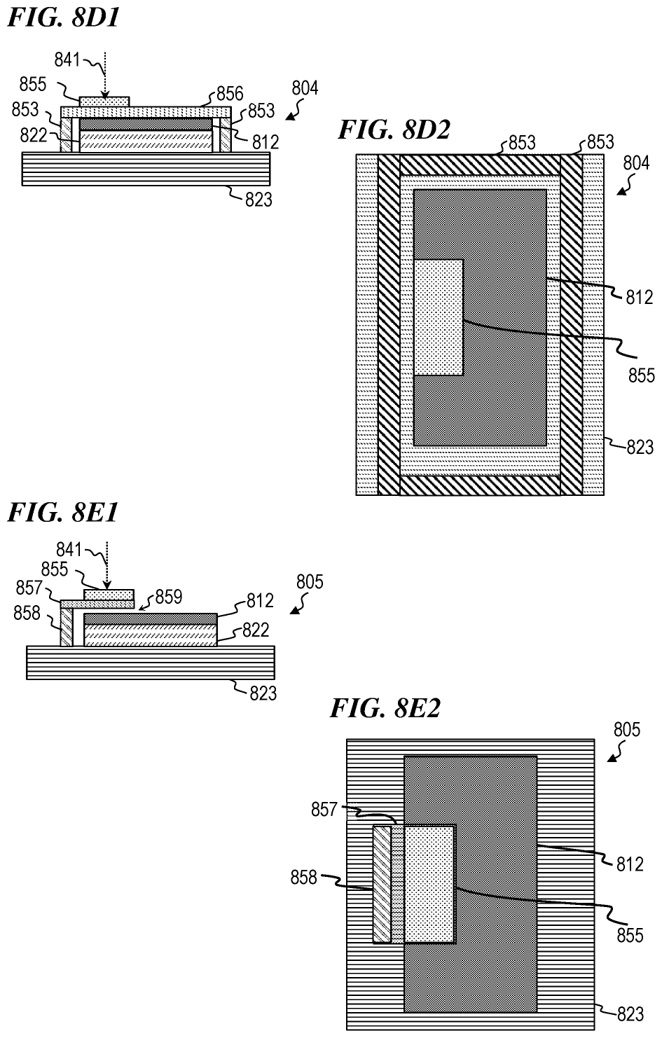

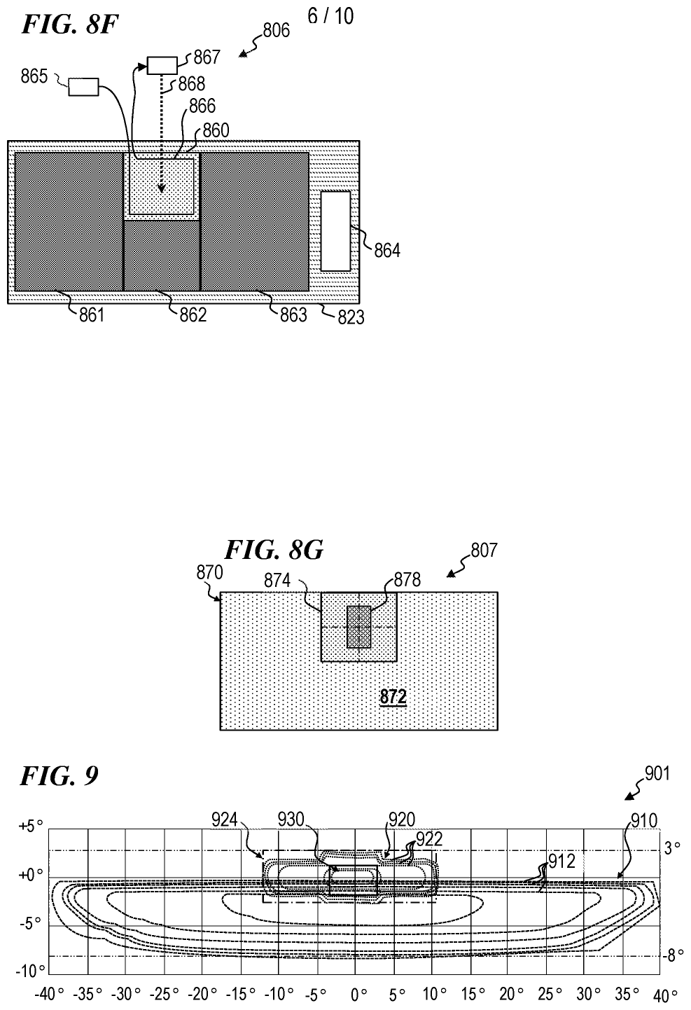

In some embodiments, light beam 343 is imaged onto DMD 314, which in some embodiments, includes a plurality of individually activatable micromirrors, generating an output beam 344 that is used to provide a smart headlight with a selectably activated hot spot for the high beam. In some embodiments, light source 301 has white-LED assembly 323, collimating-lens assembly 331, pumping laser 321, and blue-reflecting mirror 313 housed inside enclosure 315, which also functions as a heatsink. In some embodiments, transparent window 318 seals enclosure 315 to protect the inside structure of light source 301 from dust, moisture, and corrosion. In some embodiments, coupling lens 332 is used to image the LED/laser/phosphor light onto DMD 314 through the TIR prism assembly 340, with the output 344 of the DMD 314 projected to the roadway, optionally using optional projection-lens assembly 350 (which includes one or more lenses; in other embodiments, projection-lens assembly 350 is replaced by a concave projection reflector assembly (not shown)). In various embodiments, any of the LED structures shown in FIG. 2A, FIG. 2B, FIG. 8A1, FIG. 8B1, FIG. 8C1, FIG. 8D1, FIG. 8E1, FIG. 8F, or FIG. 8G are used for white-LED assembly 323.

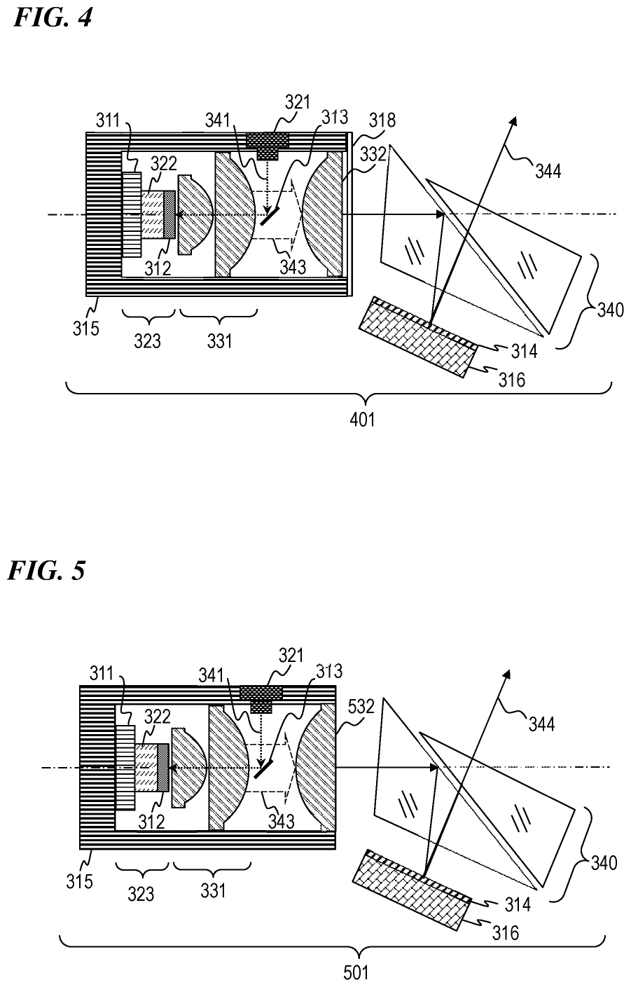

FIG. 4 is a side-cross-sectional-view block diagram of a hybrid LED/laser-pumped-phosphor light source 401, according to some embodiments of the present invention. In some embodiments, light source 401 is substantially equivalent to light source 301 of FIG. 3, except that, in light source 401 as shown in FIG. 4, the coupling lens 332 is placed inside enclosure 315 behind transparent window 318 such that the output light 343 from enclosure 315 directly illuminates the DMD 314 through the TIR-prism assembly 340.

FIG. 5 is a side-cross-sectional-view block diagram of a hybrid LED/laser-pumped-phosphor light source 501, according to some embodiments of the present invention. In some embodiments, light source 501 is substantially equivalent to light source 301 of FIG. 3, except that for light source 501, as shown FIG. 5, if the additional protection of window 318 is not needed; the transparent window 318 is removed, exposing the coupling lens 532 to the outside. In some embodiments, coupling lens 532 includes a hard outer coating, similar to the transparent window 318 of FIG. 3, and coupling lens 532 is sealed to enclosure 315, providing the sealing function of the window.

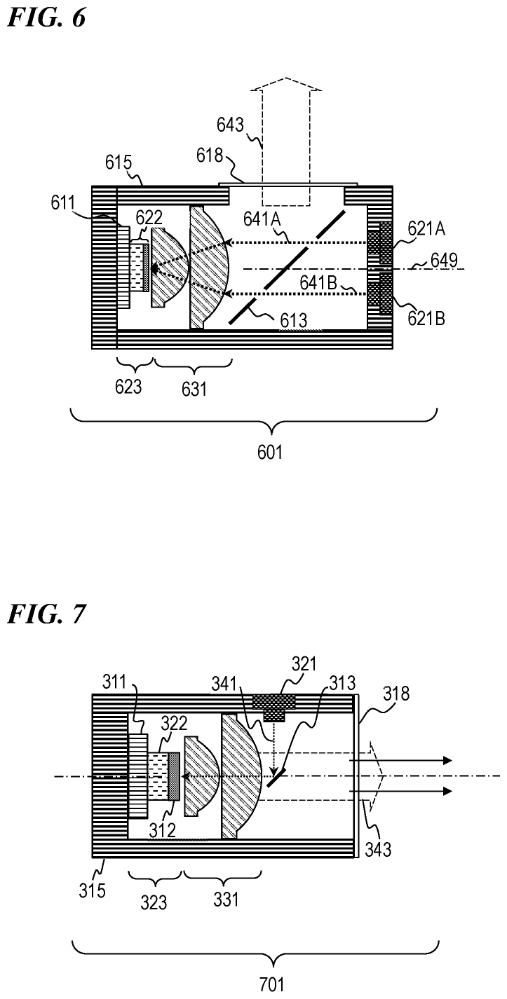

FIG. 6 is a side-cross-sectional-view block diagram of a side-emitting hybrid LED/laser-pumped-phosphor light source 601, according to some embodiments of the present invention. In some embodiments, light source 601 includes an LED assembly 623 that includes an LED assembly 622 (e.g., in some embodiments, an LED that emits light of a blue color combined with a phosphor wavelength-conversion layer (not separately labeled in this block diagram)) mounted to a heatsink 611 that conducts heat away from LED assembly 622 and conducts that heat to enclosure 615 that provides additional external surface area to dissipate heat. In various embodiments, any of the LED-phosphor structures shown in FIG. 2A, FIG. 2B, FIG. 8A1, FIG. 8B1, FIG. 8C1, FIG. 8D1, FIG. 8E1, FIG. 8F, or FIG. 8G are used for LED assembly 622. In some embodiments, heatsink 611 and enclosure 615 are a single piece of metal or other thermally conductive material. In some embodiments, heatsink 611 is omitted and LED assembly 622 is directly affixed to enclosure 615. In some embodiments, enclosure 615 includes a plurality of external fins (either as part of the enclosure structure or as a clip-on or other externally attached additional structure) to provide additional surface area to radiate and/or conduct heat to the local environment. In some embodiments, a plurality of lasers 621A . . . 621B is mounted to the end of enclosure 615 in order that enclosure 615 also dissipates heat from the plurality of lasers 621A . . . 621B. In some embodiments, mirror 613 includes a plurality of through-openings corresponding to the plurality of laser beams 641A . . . 641B, which are focused by lens assembly 631 to a center location on LED assembly 622 to form a hot spot of increased light output there, in a manner similar to light source 301 of FIG. 3. In some embodiments, the plurality of laser beams 641A . . . 641B are initially parallel to one another around center axis 649 as emitted from lasers 621A . . . 621B. In other embodiments, the plurality of laser beams 641A . . . 641B are initially converging toward center axis 649 as emitted from lasers 621A . . . 621B. In some embodiments, the number of lasers 621A . . . 621B is two, while in other embodiments, three, four, six, seven or other suitable number of lasers are provided in a symmetrical arrangement around a center axis. In some embodiments, a single laser 621A is used (and optionally is centrally located along center axis 649). In some embodiments, mirror 613 is oriented at a 45° angle (or other suitable angle) to direct the output beam 643 through a side opening that, in some embodiments, is covered and sealed by window 618. The resulting overall light from LED assembly 623, including the hot spot additionally pumped by the plurality of laser beams 641A . . . 641B, is collimated by collimating lens assembly 631 and reflected by mirror 613 to form output beam 643 that is substantially collimated white light (which includes unconverted blue light from the plurality of laser beams 641A . . . 641B and wavelength-converted yellow light from phosphor portion(s) of LED assembly 622 pumped by light from the plurality of laser beams 641A . . . 641B). In some embodiments, planar transparent window 618 seals the light-exit side opening of enclosure 615. In some embodiments, a coupling lens (not shown) images beam 643 onto a DMD (not shown).

FIG. 7 is a side-cross-sectional-view block diagram of a hybrid LED/laser-pumped-phosphor light source 701, according to some embodiments of the present invention. In some embodiments, light source 701 is substantially equivalent to light source 301 of FIG. 3, except that light source 701 omits the coupling lens and TIR prism assembly of light source 301.

FIG. 8A1 is a side-cross-sectional-view block diagram of an LED/laser-pumped-phosphor light source assembly 801, according to some embodiments of the present invention. For simplicity, clarity and generality, the one or more laser beams that pump the top phosphor are shown schematically as laser beam 841 in FIGS. 8A1, 8B1, 8C1, 8D1, and 8E1.

In some embodiments, assembly 801 includes a blue-light LED 822 affixed to heatsink 823, a phosphor layer 812 affixed to blue-light LED 822, and a crystal phosphor layer 851 affixed to phosphor layer 812. As compared to FIG. 2A, LED/laser-pumped-phosphor light source assembly 801 has the additional crystal phosphor layer 851 on top of the phosphor layer 812, which is deposited on blue-light LED 822. In some embodiments, this additional crystal phosphor layer 851 is glued or fused (e.g., via thermal and/or ultrasonic and/or other energy) onto the phosphor layer 812 such that it becomes an integral part of the light source assembly 801. One advantage of such a structure is that the crystal phosphor 851 has a much higher temperature rating and/or power-density rating as compared to the standard silicone-based phosphor, and crystal phosphor 851 is more transparent to yellow light as compared to ceramic-phosphor or glass-phosphor layers. As a result, the yellow portion of the wavelength-converted LED light from phosphor layer 812 will pass through this layer of crystal phosphor 851 with very little loss. In some embodiments, the blue portion of LED light will be partially absorbed by crystal phosphor 851 (and wavelength converted to additional yellow light), thereby lowering the color temperature of the output light due to the reduced proportion of blue light. In some embodiments, the blue-light LED 822 is designed and/or electrically driven to output extra blue light such that the desired output amount of blue will be obtained after it passes through (and is partially wavelength converted by) the crystal phosphor layer 851. Using this additional layer of crystal phosphor 851, the output 841 of the laser that front-side pumps assembly 801 (e.g., laser 121 of FIG. 1, or laser 321 of FIGS. 3-5 and 7, or lasers 621A . . . 621B of FIG. 6) can be increased, as the laser light will be absorbed and wavelength converted by the crystal phosphor layer 851 with its higher rating on both operating temperature and power density, thus allowing a much-higher-intensity hot spot on LED/laser-pumped-phosphor light source 801.

FIG. 8A2 is a plan-view block diagram of LED/laser-pumped-phosphor light source assembly 801.

FIG. 8B1 is a side-cross-sectional-view block diagram of an LED/laser-pumped-phosphor light source assembly 802, according to some embodiments of the present invention. In some embodiments, LED/laser-pumped-phosphor light source assembly 802 includes a blue-light LED 822 affixed to heatsink 823, a phosphor layer 812 affixed to blue-light LED 822, and a crystal phosphor 852 affixed to heat-conducting structures 853 that are affixed to heatsink 823 and separated by an offset distance to the sides of phosphor layer 812. Heat-conducting structures 853 are provided to provide a heat-conduction path from crystal phosphor plate 852 to heatsink 823, and are sized such that crystal phosphor plate 852 is separated by a gap 854 (of air or other gas or a vacuum) from phosphor layer 812. In this configuration, the original LED 822 and its phosphor layer 812 are not physically “touched” by the additional components 852 and 853, thus preserving the integrity of the original assembled LED 822 and its phosphor layer 812. There has been a tremendous amount of research and development done in improving the performance of white LEDs, and it is important to capitalize on these development efforts when making improvements. With a small gap 854 between the standard white LED structure 812/822 and the crystal phosphor plate 852, the best commercially available LED can be used, providing the best possible system for this “hot spot” LED assembly 802 using laser pumping. In a manner similar to the white LED 812/822 shown in FIG. 8A, in some embodiments, the white LED 812/822 of FIG. 8B is designed and/or electrically driven to output extra blue light such that the desired amount of output blue will be obtained after it passes through the crystal phosphor layer 852. Using this additional layer 852, the output power of the laser beam 841 that front-side pumps assembly 802 can be increased, as the laser light will be absorbed by the crystal phosphor layer 852 with its higher rating on both operating temperature and power density, thus allowing a much-higher-intensity hot-spot output of LED/laser-pumped-phosphor light source assembly 802.

FIG. 8B2 is a plan-view block diagram of LED/laser-pumped-phosphor light source assembly 802.

FIG. 8C1 is a side-cross-sectional-view block diagram of an LED/laser-pumped-phosphor light source assembly 803, according to some embodiments of the present invention. In some embodiments, assembly 803 includes a blue-light LED 822 affixed to heatsink 823, a phosphor layer 812 affixed to blue-light LED 822, and a crystal phosphor plate 855 that is smaller than phosphor layer 812 and affixed to a portion of phosphor layer 812. As compared to FIG. 8A1, LED/laser-pumped-phosphor light source assembly 803 has the additional layer of crystal phosphor 855 affixed on top of a portion of the phosphor layer 812, which is deposited on blue-light LED 822. In some embodiments, assembly 803 is substantially equivalent to assembly 801 of FIG. 8A1, except that the additional layer of crystal phosphor 855 covers only a portion (in some embodiments, less than half) of the outer surface of phosphor layer 812.

FIG. 8C2 is a plan-view block diagram of LED/laser-pumped-phosphor light source assembly 803.

FIG. 8D1 is a side-cross-sectional-view block diagram of an LED/laser-pumped-phosphor light source assembly 804, according to some embodiments of the present invention. In some embodiments, assembly 804 includes a blue-light LED 822 affixed to heatsink 823, a phosphor layer 812 affixed to, or deposited on, blue-light LED 822, a transparent heatsink window 856 affixed to a heat-conductive surrounding wall 853 that surrounds a perimeter of (but is separated by a gap from) blue-light LED 822 and phosphor layer 812, and a crystal phosphor plate 855 that is smaller than phosphor layer 812 and affixed to a portion of transparent heatsink layer 856. As compared to FIG. 8A1, LED/laser-pumped-phosphor light source assembly 804 has the additional layer of crystal phosphor 855 affixed on top of a portion of transparent heatsink layer 856, which covers blue-light LED 822 and phosphor layer 812. In some embodiments, assembly 804 is substantially equivalent to assembly 802 of FIG. 8B1, except that heat-conductive surrounding wall 853 surrounds the entire perimeter of (but is separated by a gap from) blue-light LED 822 and phosphor layer 812, and is covered and sealed by transparent heatsink window 856, thus sealing that blue-light LED 822 and phosphor layer 812; and the additional crystal phosphor plate 855 covers only a portion (in some embodiments, less than half) of the outer surface of phosphor layer 812, from which it is separated by transparent heatsink window 856. In some embodiments, transparent heatsink window 856 is made of sapphire, quartz, or other suitable material, such that blockage of light emitted from the LED is minimized. In some embodiments, transparent heatsink 855 is in turn mounted on heatsink wall 853 around LED assembly 822-812, such that heat from phosphor plate 856 is conducted away to LED heatsink 823 through transparent heatsink window 856. In some embodiments, transparent heatsink window 856 is made of a transparent heatsink material such as synthetic diamond or aluminum oxynitride (AlON ceramic, such as ALON-brand by Surmet Corp., or such as described in U.S. Pat. No. 4,520,116 by Gentilman et al. titled “Transparent aluminum oxynitride and method of manufacture” or U.S. Pat. No. 4,686,070 by Maguire, et al. titled “Method of producing aluminum oxynitride having improved optical characteristics,” or the like). In other embodiments, where a sealed compartment is not required, transparent heatsink layer 856 can use a perforated metal such as an aluminum honeycomb plate, or aluminum sheet having etched or punched holes therethrough, or the like.

FIG. 8D2 is a plan-view block diagram of LED/laser-pumped-phosphor light source assembly 804.

FIG. 8E1 is a side-cross-sectional-view block diagram of an LED/laser-pumped-phosphor light source assembly 805, according to some embodiments of the present invention. In some embodiments, assembly 805 includes a blue-light LED 822 affixed to heatsink 823, a phosphor layer 812 affixed to, or deposited on, blue-light LED 822, a cantilevered heatsink platform 857 affixed to a heat-conductive wall 858 that is near a perimeter of (but that is separated by a gap from) blue-light LED 822 and phosphor layer 812, and a crystal phosphor plate 855 that is smaller than phosphor layer 812 and affixed to a portion of heatsink platform 857 which is suspended and separated above phosphor layer 812. In some embodiments, assembly 805 includes a reflective crystal phosphor plate 855 placed on top of a cantilevered heatsink 857-858 connected to the LED heatsink 823 around LED 822 and its phosphor layer 812, such that the heat generated from the reflective crystal phosphor plate 855 is dissipated to heatsink 823. There is a small gap 859 between the crystal phosphor plate 855's heatsink 857-858 and LED assembly 812-822, and crystal phosphor plate 855.

In another embodiment, phosphor plate 855 (which, in some embodiments, may be a crystal phosphor or other phosphor-containing layer) is partially transparent and mounted on a transparent heatsink 857, such as sapphire, quartz, synthetic diamond, or other suitable material, such that part of the LED emission (e.g., in some embodiments, blue light from LED 822 and yellow light from phosphor layer 812) is transmitted through phosphor plate 855, increasing the output at the phosphor-plate area. In this case, phosphor plate 855 together with the original LED's phosphor layer 812 form a composite layer, such that the original LED's phosphor layer 812 absorbs most of the LED blue light from LED 822, with very little absorbed by phosphor plate 855. At the same time, most of the laser light is absorbed by the phosphor plate 855 and very little is absorbed by the LED's phosphor layer 812. This combination allows the use of high-efficiency LED phosphor 812 for broad-area emission and the use of high-temperature phosphor plate 855 for small-spot emission. As compared to LED/laser-pumped-phosphor light source assembly 803 of FIG. 8C1, LED/laser-pumped-phosphor light source assembly 805 has the additional layer of crystal phosphor 855 affixed on top of a portion of heatsink platform 857, which covers a small portion of blue-light LED 822 and phosphor layer 812. In some embodiments, heatsink platform 857 is made of a metal with high heat conductivity, and has a highly reflective upper surface to reflect any downward-directed pump light or wavelength-converted yellow light back upward into or through phosphor plate 855. In other embodiments, heatsink platform 857 is a transparent plate such as transparent heatsink layer 856 described above for FIGS. 8D1 and 8D2. In some embodiments, assembly 805 is substantially equivalent to assembly 803 of FIG. 8C1, except that heat-conductive wall 858 that is near the perimeter of (but separated by a gap from) blue-light LED 822 and phosphor layer 812 holds cantilevered heatsink platform 857, thus separating, by a small gap 859, the additional crystal phosphor plate 855 from blue-light LED 822 and phosphor layer 812. In some embodiments, cantilevered heatsink platform 857 and crystal phosphor plate 855 cover only a portion (in some embodiments, less than half) of the outer surface of phosphor layer 812.

FIG. 8E2 is a plan-view block diagram of LED/laser-pumped-phosphor light source assembly 805.

FIG. 8F is a schematic front-view block diagram of a light-emitting structure 806 having three white LED emitters 861, 862, and 863 and a reflective phosphor plate 860, according to some embodiments of the present invention. Using similar assembly processes as described for FIG. 8C1, FIG. 8D1 or FIG. 8E1, various embodiments of the present invention include a hybrid light source 806 with an LED-phosphor structure 861-862-863 together with a reflective phosphor plate 860, assembled on the same heatsink 823, as shown in FIG. 8F. In some embodiments, phosphor plate 860 is a crystal phosphor plate that is mounted directly on a surface of heatsink 823, which, in some embodiments, is reflective. In some embodiments, since no LED area is below phosphor plate 860, phosphor plate 860 is made reflective on its bottom surface so that the blue laser light and yellow wavelength converted light are reflected back toward the top emitting output surface. In this specific embodiment, three LEDs 861-862-863 are used to provide the U-shaped emitting area and a rectangular reflective phosphor plate 860 is used to fill the balance of the area. In some embodiments, LEDs 861-862-863 and phosphor plate 860 are soldered onto heatsink 823 and LEDs 861-862-863 are wire bonded to LED drive circuit 864 on heatsink 823. In some embodiments, phosphor plate 860 is optically pumped by one or more lasers 867, and does not have wire bonding to LED drive circuit 864. In some embodiments, for safety reasons, a safety circuit 866 (in series electrically between laser control circuit 865 and laser 867) is integrated into, or closely associated with, phosphor plate 860, such that when plate 860 is broken, safety circuit 866 is opened, thereby interrupting the flow of electric current supplying laser 867, and/or the break is detected by laser control circuit 865, which then turns off laser 867, reducing the risk of leaking laser light 868 outside of the headlight.

FIG. 8G is a plan-view block diagram of an illumination pattern 807 as projected onto a DMD 870, according to some embodiments of the present invention. In some embodiments, the active area of DMD 870 has a 2:1 aspect ratio. In some embodiments, in order to have the full profile projected toward the roadway (which, in some embodiments, needs an 8:1 aspect ratio) contained inside the active area of DMD 840 with its 2:1 aspect ratio, the output from DMD 840 is projected onto the roadway using an astigmatic lens with a horizontal magnification aspect ratio of 4:1, so that the 2:1 aspect ratio of the light from DMD 840 is magnified to become 8:1. In this case, the regions inside the micromirror array of DMD 870 are as shown in FIG. 8G, with the LED-pumped phosphor-light illuminating area 872 for projecting as the low beam, a medium-high-intensity area 874 being light from a laser-pumped crystal phosphor or other phosphor layer for projecting as the high beam, and a very-high-intensity area 878 being light from a more-highly-laser-pumped crystal phosphor, for projecting as an extreme high beam, according to some embodiments of the present invention.

FIG. 9 shows the intensity profile combining the low beam, high beam, and the ultra-high beam. In some embodiments, using a light source that provides illumination pattern 807 as shown in FIG. 8G, with one base brightness for area 872, one medium hot spot for area 874, and one high hot spot for area 878 to illuminate a 2:1 aspect-ratio DMD, an 8:1 aspect-ratio intensity profile can be produced using a 4:1 expansion-ratio anamorphic lens. With such a profile projected onto the roadway together with the intensity-modulation capability of the DMD under the control of a controller (such as shown in FIG. 17, described below), the desired output intensity profile is produced, such as low beam only, high beam only, or ultra-high beam only, or a desired combination. In some embodiments, the resulting low-beam, high-beam, and extreme-high-beam illumination patterns are as shown in FIG. 9.

Continuing, FIG. 9 is a schematic diagram of an illumination pattern 901 of an automotive headlight, according to some embodiments of the present invention. Illumination pattern 901 shows the intensity profile, with successively higher iso-intensity lines toward a center area, of the low beam 910, high beam 920, and extreme high beam 930 of an automotive headlight, in terms of both horizontal and vertical directions, which has an aspect ratio of 8:1. In some embodiments, low beam 910 extends vertically from −8° (below horizontal) to 0° (at horizontal), and extends horizontally from −40° (left of center) to +40° (right of center) surrounded by the dash-dot-dot line), and the low-beam iso-intensity lines 912 are successively higher toward a center area of low beam 910. In some embodiments, high beam 920 extends vertically from −2° (below horizontal) to +3° (above horizontal), and extends horizontally from about −12° (left of center) to about +12° (right of center) surrounded by the dash-dot line), and the high-beam iso-intensity lines 922 are successively higher toward a center area of high beam 920. In some embodiments, extremely-high beam 930 extends vertically from −1° (below horizontal) to +2° (above horizontal), and extends horizontally from about −3° (left of center) to about +3° (right of center) surrounded by the heavy solid line), and the extreme-high-beam iso-intensity lines are successively higher toward a center area of extremely high beam 930.

In order to provide the automotive-headlight-intensity profile required, the light source of some embodiments of the present invention provides higher intensity at the top center of the headlight beam, and a more uniform, lower intensity for the rest of the area.

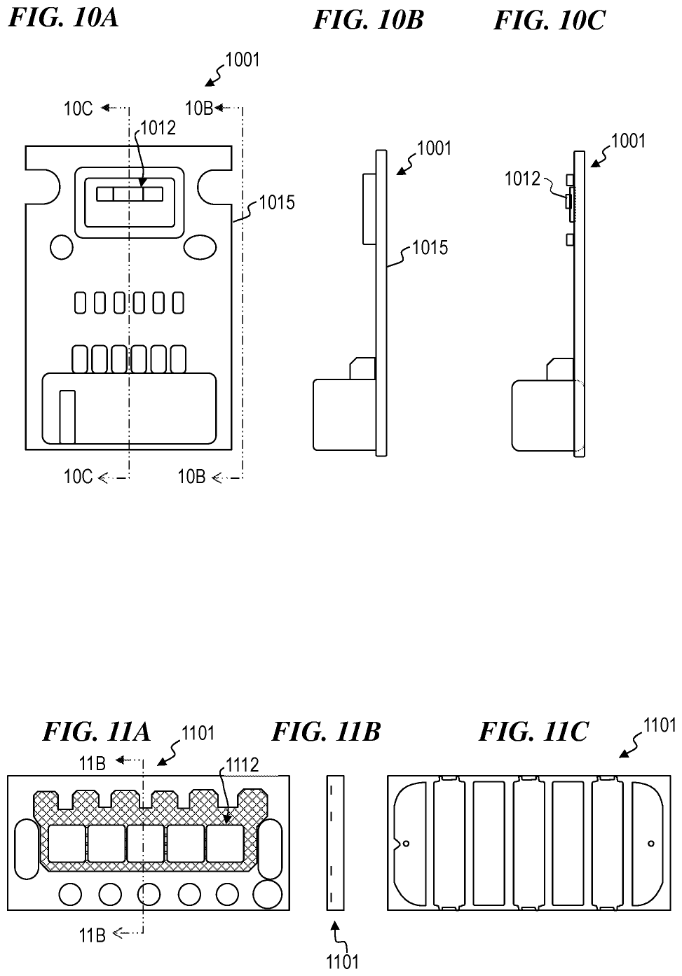

FIG. 10A is a front-view block diagram of a commercial LED assembly 1001, which is used in some embodiments of the present invention. In some embodiments, LED assembly 1001 has a rectangular emitting area 1012, wherein LED assembly 1001 includes four rectangular LEDs placed side by side to form rectangular emitting area 1012. In some embodiments, LED assembly 1001 includes heat sink 1015 and is used for smart headlight applications. In some embodiments, LED assembly 1001 is used for various embodiments of the hybrid light source (such as LED assembly 123 of FIG. 1, or LED assembly 323 of FIG. 3, 4, 5, or 7, for a DMD headlight, wherein the output from the hybrid light source is collimated using the collimating lens system 331). One or more collimated lasers (such as laser 121 of FIG. 1, or laser 321 of FIG. 3, 4, 5, or 7, or lasers 621A . . . 621B of FIG. 6, for a DMD headlight, wherein the output from the hybrid light source is collimated using the collimating lens system 331) are used together, optionally with the blue-reflecting wavelength-selective filter (such as mirror 313 of FIG. 3, 4, 5, or 7), or mirror 613 of FIG. 6, such that the outputs of the lasers are impinged onto the phosphor plate in the hybrid light source.

FIG. 10B is a side-view block diagram of LED assembly 1001 from dash-dot-dot line 10B of FIG. 10A.

FIG. 10C is a side-cross-sectional-view block diagram of LED assembly 1001 at dash-dot-dot line 10C of FIG. 10A.

FIG. 11A is a front-view diagram of another commercial LED assembly 1101 with a long rectangular emitting area 1112, wherein LED assembly 1101 includes five rectangular LEDs, which is used in some embodiments of the present invention. In some embodiments, the row of LEDs is connected together and controlled as a single unit, while in some other embodiments each LED is controlled individually with its own contacts. From these examples, one recognizes that mounting LEDs close to each other is an existing process and is already qualified for use in automotive applications.

FIG. 11B is a side-cross-sectional-view block diagram of LED 1101 at dash-dot-dot line 11B of FIG. 11A.

FIG. 11C is a back-view block diagram of LED 1101.

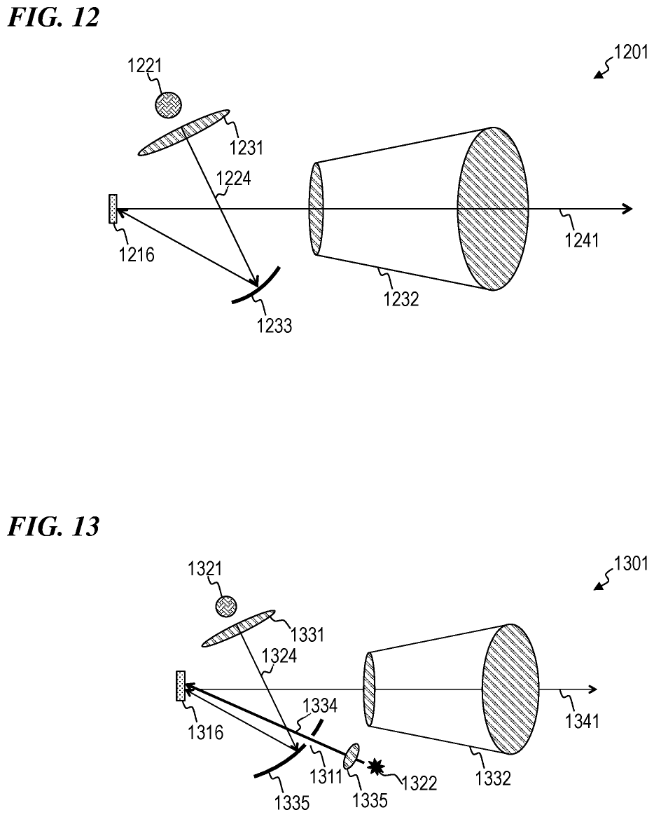

FIG. 12 is a side-cross-sectional-view block diagram of still another hybrid LED/laser-pumped-phosphor light source 1201, according to some embodiments of the present invention. In some embodiments, light source 1201 is a standard DMD projector in which the output of light source 1221, which, in some embodiments, is or includes an LED, is coupled to DMD 1216 using one or more coupling lenses 1231 and a concave reflector 1233. In some embodiments, the placement of the optics 1231-1233 is such that the light reflected by the concave reflector 1233 is incident at the DMD 1216 at 24 degrees, such that when selected individual mirrors of DMD 1216 are turned −12 degrees, the light is reflected to the output projection lens 1232. The 24 degrees and 12 degrees described for FIG. 12 are per DMD specifications for a given DMD. Other angles are used if different DMDs with different specifications are used. The combination of the coupling lens 1231 and the concave reflector 1233 projects the image of the light source 1221 onto DMD 1216, providing an efficient coupling. Using this configuration, it is possible to add a hot spot to the output by adding the hot spot onto the DMD instead of adding the hot spot at the light source. In particular, for this configuration, the hot spot can be added through an aperture at the concave reflector, as shown in FIG. 13.

FIG. 13 is a side-cross-sectional-view block diagram of yet still another hybrid LED/laser-pumped-phosphor light source 1301, according to some embodiments of the present invention. In some embodiments, light source 1301 includes a high-brightness light source 1322 that is used to provide the hot spot for projection onto the roadway. As shown in FIG. 13, the output from the high-brightness light source 1322 is coupled onto the DMD 1316 using one or more coupling lenses 1335. Light 1324 from light source 1321 (e.g., in some embodiments, an LED source) is coupled onto DMD 1316 using lens 1331 and concave reflector 1335. To maximize brightness, the light source is imaged onto the DMD using the coupling lenses, which conserves the brightness (etendue) from the high-brightness light source 1322 onto the DMD 1316. Since the high-brightness light beam 1334 is coupled through the aperture 1311 of the concave reflector 1335, it is possible to position the hot-spot light (i.e., from light beam 1334) at any location of the DMD 1316, and the reflected light will be coupled efficiently to the output projection lens 1332. In some embodiments, the position of the hot-spot light is the center of the DMD 1316, while in some other embodiments, the position of the hot-spot light is at the top position of the DMD, as shown in FIG. 8G. In some embodiments, one or more high-brightness light sources 1322 are used, with their light going through the same aperture 1311 or using a plurality of such apertures, such that the desired intensity profile is achieved. In various embodiments, the concave reflector 1335 is spherical, parabolic, or aspheric.

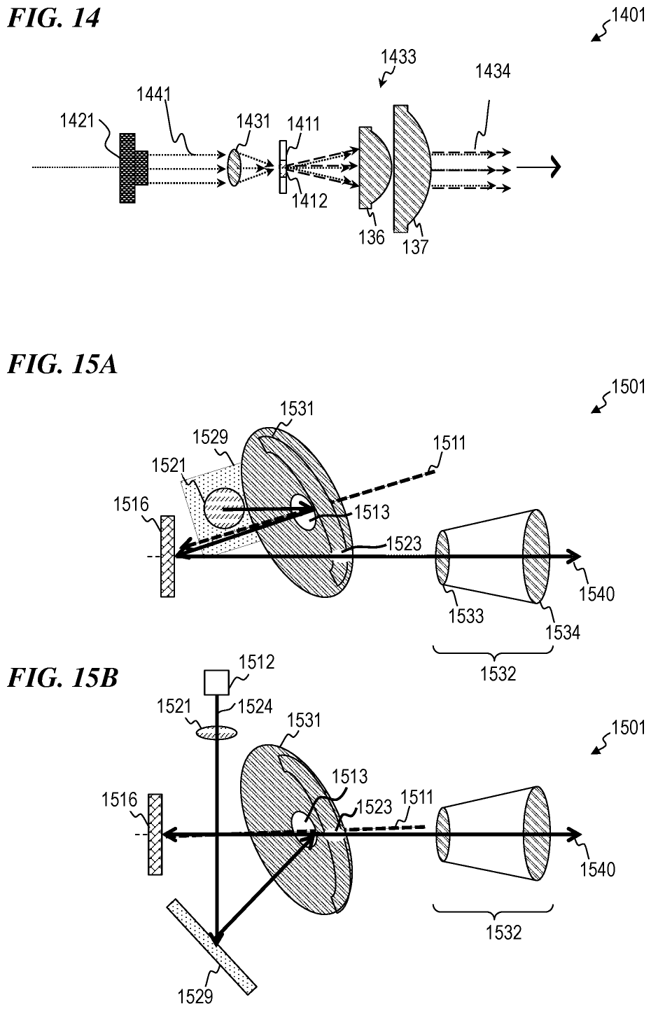

FIG. 14 is a side-cross-sectional-view block diagram of a laser-pumped-phosphor light source 1401 that is usable for high-brightness light source 1322 of FIG. 13, according to some embodiments of the present invention. In some embodiments, laser-pumped-phosphor light source 1401 includes a laser 1421 that emits a collimated blue-light laser beam 1441 (indicated by dotted-line arrows) that is focused by lens 1431 or other optics to a center location 1412 on phosphor plate 1411. In some embodiments, phosphor plate 1411 includes phosphor materials such as glass phosphor, ceramic phosphor, or crystal phosphor. In some embodiments, the phosphor plate 1411 is made small and heat (generated by the absorbed light and wavelength-conversion process) is conducted through, and/or dissipated by, a carrier plate (not shown) in which the phosphor material is mounted. The phosphor of phosphor plate 1411 absorbs the focused blue light from the laser 1421 and emits an intense radiation beam with a very small cross-section area, providing a very bright light source. In some embodiments, a portion of the shorter-wavelength (e.g., blue color) pump light (indicated by dotted-line arrows) passes through phosphor plate 1411 and another portion is wavelength-converted to longer-wavelength (e.g., yellow color) wavelength-converted light (indicated by dashed-line arrows), and the combined blue-color pump light and yellow-color wavelength-converted light is collimated by collimating lens 1433 (in some embodiments, lens 136 and lens 137) to form collimated output beam 1434, which is, in some embodiments, used as high-brightness light beam 1334 of FIG. 13 or high-brightness light beam 1511 of FIG. 15A and FIG. 15B.

FIG. 15A is a side-cross-sectional-view block diagram of still another hybrid LED/laser-pumped-phosphor light source 1501, according to some embodiments of the present invention.

FIG. 15B is a top-cross-sectional-view block diagram of hybrid LED/laser-pumped-phosphor light source 1501.

FIGS. 15A and 15B show the structure of a high-brightness light source 1501 using blue laser diodes. In some embodiments, one or more laser-pumped-phosphor light sources (such as source 1401 of FIG. 14) with collimated beams 1511 are used. As shown in the side view of FIG. 15A and the top view of FIG. 15B, the high-brightness light source beam 1511 is provided through a first aperture 1513 in the concave mirror 1531 (shown partially in cross-section), such that the collimated high-brightness light source beam 1511 imaged onto the DMD 1516 is projected through a second aperture 1523 to collimating lens assembly 1532 (in some embodiments, including lens 1533 and lens 1534) to form the high-beam portion of output beam 1540. In some embodiments, a wide-beam lower-intensity light pattern is obtained by projecting, onto DMD 1516, an LED-pumped white light beam 1524 from LED 1512 using lens 1521, flat reflector 1529, and concave reflector 1531. This wide-beam lower-intensity light pattern on DMD 1516 is also propagated through aperture 1513 to form the low-beam portion of output beam 1540.

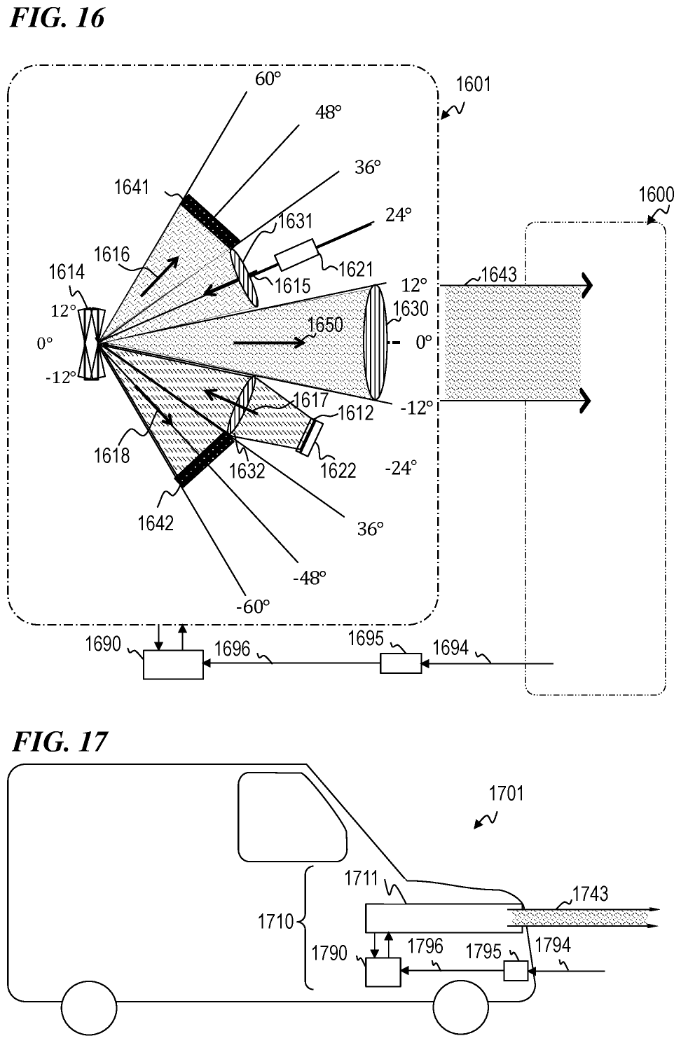

FIG. 16 is a top-cross-sectional-view block diagram of a DMD-based LED/laser-pumped-phosphor light source 1601, according to some embodiments of the present invention, in which the optical path is based on a low-cost commercial projector. In some embodiments, light source 1601 includes a white-light LED formed of blue-light LED 1622 and its phosphor cover layer 1612, and a high-intensity source 1621 and DMD 1614 that has a plurality of micromirrors, each micromirror individually angled to a first predetermined angle or a second predetermined angle (in some embodiments, angles of −12° or +12°) under the control of controller 1690. In some embodiments, controller 1690 also selectively controls the brightness of low-beam light 1617 and high-beam light 1615. In some embodiments, blue-light LED 1622 and its phosphor cover layer 1612 together provide a relatively wide and relatively lower-intensity white-light beam 1617 (for the low-beam part of the headlight output 1643) that is imaged onto the plurality of individually selectable micromirrors of DMD 1614, that, when angled at −12° (each micromirror angled under the control of controller 1690), each reflect their portion of light 1618 to light dump 1642, but when angled at +12°, each reflect their portion of light in direction 1650 to projection lens 1630 that projects that light as a low-beam portion of headlight beam 1643. Similarly, high-intensity source 1621 provides a relatively narrow and relatively higher-intensity white-light beam 1615 (for the high-beam part of the headlight output 1643) that is imaged onto a centrally located subset of the plurality of individually selectable micromirrors of DMD 1614, that, when angled at +12° (each micromirror angled under the control of controller 1690), each reflect their portion of light 1616 to light dump 1641, but when angled at −12°, each reflect their portion of light in direction 1650 to projection lens 1630 that projects that light as a high-beam portion of headlight beam 1643. Thus, each micromirror of DMD 1614, when angled at the second angle (e.g., +12°), selects light 1617 from LED 1622 and phosphor 1612 to be output to headlight beam 1643, but when angled at the first angle (e.g., −12°), selects light 1615 from high-intensity source 1621 to be output to headlight beam 1643. In some embodiments, the positions of various component micromirrors of DMD 1614 are controlled by controller 1690 in a manner that both low-beam light 1617 and high-beam light 1615 are combined together as a combined low-beam and high-beam pattern in headlight beam 1643 projected by lens 1640. In some embodiments, projection lens 1640 is replaced by a concave projection reflector that reflects both low-beam light 1617 and high-beam light 1615 combined together as a combined low-beam and high-beam pattern in headlight beam 1643, as described above. In some embodiments, this sensing/controlling function is optionally activatable and deactivatable by the human driver (analogous to automobile “cruise control”).

In some embodiments, a scene sensor 1695 is configured to actively (e.g., using LiDAR or the like) and/or passively (using a camera or the like) sense the environment 1600 around the vehicle in which DMD-based LED/laser-pumped-phosphor light source 1601 is housed, and the received signals or data 1694 received by sensor 1695 are processed into sensed data 1696 and operatively coupled to processor 1690, which then adjusts the shape, direction and/or intensity of various low-beam, high-beam and/or extreme-high-beam portions of headlight beam 1643 as described above.

FIG. 17 is a block diagram of a vehicle 1701 that includes an LED/laser-pumped-phosphor light source 1711, according to some embodiments of the present invention. In some embodiments, a scene sensor 1795 is configured to actively (e.g., using LiDAR or the like) and/or passively (using a camera or the like) sense the environment around the vehicle 1701 in which LED/laser-pumped-phosphor light source 1711 is housed, and the received signals or data 1794 received by sensor 1795 are processed into sensed data 1796 and operatively coupled to processor 1790, which then adjusts the shape, direction and/or intensity of various low-beam, high-beam and/or extreme-high-beam portions of headlight beam 1743 as described above. In some embodiments, this sensing/controlling function is optionally activatable and deactivatable by the human driver (analogous to automobile “cruise control”).

In some embodiments, the present invention provides a first apparatus (such as illustrated in FIG. 1, 3, 4, 5, 6, or 7) that includes a hybrid light source for smart automotive-headlight applications, wherein the hybrid light source includes: a light-emitting diode (LED) light source of full-area illumination; a laser-pumped phosphor material that provides one or more areas of hot-spot illumination; a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions; and projection optics operatively coupled to receive light selectively reflected by the DMD and configured to project the received light as a beam having a shaped illumination intensity pattern.

In some embodiments of the first apparatus, the LED source further includes: a heatsink; a blue-emitting LED, mounted to the heatsink, wherein the blue-emitting LED outputs blue-LED pump light having LED pump wavelengths; and a phosphor layer located on the blue-emitting LED and operatively coupled to receive the blue-LED pump light and to wavelength-convert a portion of the blue-LED pump light to wavelength-converted LED light having longer wavelengths than the LED pump wavelengths.

Some embodiments of the first apparatus further include a pump laser that outputs a laser beam having a pump-laser wavelength, wherein the laser-pumped phosphor material is a crystal-phosphor plate operatively coupled to receive the laser beam and configured to wavelength-convert a portion of the laser-beam pump light to wavelength-converted laser light having longer wavelengths than the pump-laser wavelength.

In some embodiments of the first apparatus, the LED source further includes: a first heatsink, a blue-emitting LED, mounted to the heatsink, wherein the blue-emitting LED outputs blue-LED pump light having LED pump wavelengths, and a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and the laser-pumped phosphor material is a crystal-phosphor plate that is mounted in contact with the first phosphor layer and that covers at least a portion of a surface of the first phosphor layer.

In some embodiments of the first apparatus, the LED source further includes: a first heatsink; a blue-emitting LED, mounted to the heatsink, wherein the blue-emitting LED outputs blue-LED pump light having LED pump wavelengths; and a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and the laser-pumped phosphor material is a crystal-phosphor plate that is mounted in contact with, and covering no more than 50% of, a surface of the first phosphor layer. In some such embodiments, the crystal-phosphor plate covers no more than 40% of the surface of the first phosphor layer. In some such embodiments, the crystal-phosphor plate covers no more than 30% of the surface of the first phosphor layer. In some such embodiments, the crystal-phosphor plate covers no more than 20% of the surface of the first phosphor layer. In some such embodiments, the crystal-phosphor plate covers no more than 10% of the surface of the first phosphor layer.

In some embodiments of the first apparatus, the LED source further includes: a first heatsink; a blue-emitting LED, mounted to the heatsink, wherein the blue-emitting LED outputs blue-LED pump light having LED pump wavelengths; and a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and the laser-pumped phosphor material is a crystal-phosphor plate that is mounted to a thermally conductive structure that is in contact with the first heatsink but separated from the blue-emitting LED and the first phosphor layer by a gap, and wherein the crystal-phosphor plate covers an entirety of a surface of the first phosphor layer.

In some embodiments of the first apparatus, the LED source further includes: a first heatsink; a blue-emitting LED, mounted to the heatsink, wherein the blue-emitting LED outputs blue-LED pump light having LED pump wavelengths; and a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and the laser-pumped phosphor material is a crystal-phosphor plate that is mounted to a thermally conductive structure that is in contact with the first heatsink but separated from the blue-emitting LED and the first phosphor layer by a gap, and wherein the crystal-phosphor plate covers less than 50% of a surface of the first phosphor layer. In some such embodiments, the crystal-phosphor plate covers no more than 40% of the surface of the first phosphor layer. In some such embodiments, the crystal-phosphor plate covers no more than 30% of the surface of the first phosphor layer. In some such embodiments, the crystal-phosphor plate covers no more than 20% of the surface of the first phosphor layer. In some such embodiments, the crystal-phosphor plate covers no more than 10% of the surface of the first phosphor layer.

In some embodiments of the first apparatus, the projection optics further includes: coupling optics operatively coupled to receive light from the LED light source and the laser-pumped phosphor material; a total-internal-reflection (TIR) prism assembly (e.g., assembly 340 of FIG. 3) operatively coupled to receive light transferred from the coupling optics; and a projection-lens assembly (e.g., assembly 350 of FIG. 3) operatively coupled to receive light redirected by the TIR prism assembly and configured to project a headlight beam based on the received light from the TIR prism assembly.

In some embodiments of the first apparatus, the projection optics further includes: coupling optics operatively coupled to receive light from the LED light source and the laser-pumped phosphor material; a total-internal-reflection (TIR) prism assembly operatively coupled to receive light transferred from the coupling optics; and a concave projection-reflector assembly operatively coupled to receive light redirected by the TIR prism assembly and configured to project a headlight beam based on the received light from the TIR prism assembly.

Some embodiments of the first apparatus further include a controller (such as shown in FIG. 17) operatively coupled to the DMD and configured to selectively control the plurality of micromirrors of the DMD to adjust the shaped illumination intensity pattern for a vehicle headlight low beam and high beam. Some such embodiments further include one or more sensors (such as described in P.C.T. Patent Application No. PCT/US2020/034447, set forth above) that actively sense (such as by projecting a pulsed LiDAR illumination and sensing pulsed reflections to determine the distance to one or more external objects by time-of-flight analyses) and/or passively sense (such as by receiving visible, ultraviolet, or infrared radiation with an appropriate camera device), and used the sensed signals to adjust the shape, direction and/or intensity of a headlight illumination pattern.

Some embodiments of the first apparatus further include a vehicle (such as shown in FIG. 17), wherein the hybrid light source is mounted to the vehicle and controlled to provide smart headlight functions.

In some embodiments, the present invention provides a second apparatus (such as illustrated in FIG. 8A1, 8B1, 8C1, 8D1, 8E1, 8F, or 8G) that includes a light-source assembly, wherein the light-source assembly includes: a first heatsink; a first light-emitting diode (LED) light source affixed to the heatsink and configured to emit LED pump light having wavelengths in a first wavelength range; a first phosphor layer affixed to the first LED light source and configured to absorb at least a portion of the LED pump light such that the first phosphor layer outputs a full-area illumination that is a combination of wavelength-converted LED light having wavelengths in a second wavelength range and an unconverted portion of the LED pump light having wavelengths in the first wavelength range; and a laser-pumped second phosphor layer thermally coupled to the heatsink, wherein the laser-pumped second phosphor layer is operatively coupled to receive laser pump light and output wavelength-converted laser light such that a hotspot illumination is generated within the full-area illumination of the first phosphor layer.

In some embodiments of the second apparatus, the first wavelength range is about 420 nanometers (nm) to about 490 nm, inclusive, and wherein the second wavelength range is about 560 nm to about 660 nm, inclusive.

In some embodiments of the second apparatus, the second phosphor layer is a crystal phosphor layer.

Some embodiments of the second apparatus further include a vehicle, wherein the light-source assembly is mounted to the vehicle and controlled to provide smart headlight functions.

Some embodiments of the second apparatus further include a digital micromirror device (DMD) operatively coupled to receive the full-area illumination and the hot-spot illumination, wherein the DMD includes a plurality of micromirrors, wherein each of the plurality of micromirrors of the DMD is configured to selectively reflect light in one of a plurality of directions; and projection optics operatively coupled to receive light selectively reflected by the DMD and configured to project the received light as a beam having a shaped illumination intensity pattern.

In some embodiments of the second apparatus, the second phosphor layer is fused directly to the first phosphor layer.

Some embodiments of the second apparatus further include one or more heat-conducting structures coupled to both the heatsink and the second phosphor layer such that the one or more heat-conducting structures provide a heat-conduction path from the second phosphor layer to the heatsink, wherein the one or more heat-conducting structures are separated by an offset distance from sides of the first phosphor layer, and wherein the one or more heat-conducting structures are sized such that the second phosphor layer is separated from a major face of the first phosphor layer by a gap.

In some embodiments of the second apparatus, the second phosphor layer is fused directly to a first portion of the first phosphor layer.

In some embodiments of the second apparatus, the first phosphor layer has a first area, wherein the second phosphor layer has a second area, wherein the second area is smaller than the first area, and wherein the second phosphor layer is fused directly to a first portion of the first phosphor layer.

Some embodiments of the second apparatus further include a heat-conductive wall thermally coupled to the heatsink, wherein the heat-conductive wall surrounds a perimeter of the first LED light source and the first phosphor layer, wherein the heat-conductive wall is separated from the perimeter of the first LED light source and the first phosphor layer by a gap; and a transparent heatsink window, wherein the transparent heatsink window is thermally coupled to the heat-conductive wall and the second phosphor layer such that heat from the second phosphor layer is conducted to the heatsink through the transparent heatsink window and the heat-conductive wall.

Some embodiments of the second apparatus further include a heat-conductive wall thermally coupled to the heatsink, wherein the heat-conductive wall surrounds at least a portion of a perimeter of the first LED light source and the first phosphor layer, wherein the heat-conductive wall is separated from the perimeter of the first LED light source and the first phosphor layer by a gap; and a transparent heatsink window, wherein the transparent heatsink window is coupled to the heat-conductive wall and the second phosphor layer such that heat from the second phosphor layer is conducted to the heatsink through the transparent heatsink window, wherein the transparent heatsink window separates the first phosphor layer from the second phosphor layer, wherein the first phosphor layer has a first area, wherein the second phosphor layer has a second area, and wherein the second area is smaller than the first area.

Some embodiments of the second apparatus further include a heat-conductive wall thermally coupled to the heatsink, wherein the heat-conductive wall surrounds a perimeter of the first LED light source and the first phosphor layer, wherein the heat-conductive wall is separated from the perimeter of the first LED light source and the first phosphor layer by a gap; and a transparent heatsink window, wherein the transparent heatsink window is thermally coupled to the heat-conductive wall and the second phosphor layer such that heat from the second phosphor layer is conducted to the heatsink through the transparent heatsink window and the heat-conductive wall, wherein the transparent heatsink window is made of a material that includes aluminum oxynitride (AlON).

Some embodiments of the second apparatus further include a first heat-conductive wall thermally coupled to the heatsink, wherein the first heat-conductive wall is separated by an offset distance from a first side of the first phosphor layer; and a cantilevered heatsink platform coupled to both the first heat-conductive wall and the second phosphor layer such that heat from the second phosphor layer flows through the cantilevered heatsink platform and the first heat-conductive wall to the heatsink, wherein the cantilevered heatsink platform is suspended and separated above the first phosphor layer.

Some embodiments of the second apparatus further include a first heat-conductive wall thermally coupled to the heatsink, wherein the first heat-conductive wall is separated by an offset distance from a first side of the first phosphor layer; and a cantilevered heatsink platform coupled to both the first heat-conductive wall and the second phosphor layer such that heat from the second phosphor layer flows through the cantilevered heatsink platform and the first heat-conductive wall to the heatsink, wherein the cantilevered heatsink platform is suspended and separated above the first phosphor layer, wherein the first phosphor layer has a first area, wherein the second phosphor layer has a second area, and wherein the second area is smaller than the first area.

Some embodiments of the second apparatus further include a first heat-conductive wall thermally coupled to the heatsink, wherein the first heat-conductive wall is separated by an offset distance from a first side of the first phosphor layer; and a cantilevered transparent heatsink coupled to both the first heat-conductive wall and the second phosphor layer such that heat from the second phosphor layer flows through the cantilevered transparent heatsink and the first heat-conductive wall to the heatsink, wherein the cantilevered transparent heatsink is suspended and separated above the first phosphor layer, wherein the first phosphor layer has a first area, wherein the second phosphor layer has a second area, and wherein the second area is smaller than the first area.

In some embodiments of the second apparatus, the first LED light source is one of a plurality of LED light sources, wherein each respective LED light source of the plurality of LED light sources includes a corresponding first phosphor layer affixed to the respective LED light source, wherein the second phosphor layer is a reflective phosphor plate fused directly to at least a first one of the plurality of LED light sources.

In some embodiments of the second apparatus, the first LED light source is one of a plurality of LED light sources, wherein each respective LED light source of the plurality of LED light sources includes a corresponding first phosphor layer affixed to the respective LED light source, wherein the second phosphor layer is a reflective phosphor plate fused directly to at least a first one of the plurality of LED light sources, the light-source assembly further including: one or more lasers configured to optically pump the reflective phosphor plate, wherein the one or more lasers are supplied by an electric current; and a safety circuit integrated into the reflective phosphor plate and operatively coupled to the one or more lasers, wherein the safety circuit is configured to interrupt the electric current supplied to the one or more lasers when the reflective phosphor plate is broken.

In some embodiments, the present invention provides a third apparatus (such as illustrated in FIG. 8A1, 8B1, 8C1, 8D1, 8E1, 8F, or 8G) that includes a first heatsink; a first light-emitting diode (LED) light source affixed to the heatsink; a first phosphor layer affixed to the first LED light source; and a laser-pumped second phosphor layer thermally coupled to the heatsink, wherein the laser-pumped second phosphor layer is a crystal phosphor layer.

In some embodiments of the third apparatus, the first LED light source provides full-area illumination, and wherein the laser-pumped second phosphor layer provides hot-spot illumination, and the light-source assembly further includes: a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions; and projection optics operatively coupled to receive light selectively reflected by the DMD and configured to project the received light as a beam having a shaped illumination intensity pattern.

In some embodiments of the third apparatus, the second phosphor layer is fused directly to the first phosphor layer.

Some embodiments of the third apparatus further include one or more heat-conducting structures coupled to both the heatsink and the second phosphor layer such that the one or more heat-conducting structures provide a heat-conduction path from the second phosphor layer to the heatsink, wherein the one or more heat-conducting structures are separated by an offset distance from sides of the first phosphor layer, and wherein the one or more heat-conducting structures are sized such that the second phosphor layer is separated from the first phosphor layer by a gap.

In some embodiments of the third apparatus, the second phosphor layer is fused directly to a first portion of the first phosphor layer.

In some embodiments of the third apparatus, the first phosphor layer has a first area, wherein the second phosphor layer has a second area, wherein the second area is smaller than the first area, and wherein the second phosphor layer is fused directly to a first portion of the first phosphor layer.

Some embodiments of the third apparatus further include a heat-conductive wall coupled to the heatsink, wherein the heat-conductive wall surrounds a perimeter of the first LED light source and the first phosphor layer, wherein the heat-conductive wall is separated from the perimeter of the first LED light source and the first phosphor layer by a gap; and a transparent heatsink window, wherein the transparent heatsink window is coupled to the heat-conductive wall and the second phosphor layer such that heat from the second phosphor layer is conducted to the heatsink through the transparent heatsink window.

Some embodiments of the third apparatus further include a heat-conductive wall coupled to the heatsink, wherein the heat-conductive wall surrounds a perimeter of the first LED light source and the first phosphor layer, wherein the heat-conductive wall is separated from the perimeter of the first LED light source and the first phosphor layer by a gap; and a transparent heatsink window, wherein the transparent heatsink window is coupled to the heat-conductive wall and the second phosphor layer such that heat from the second phosphor layer is conducted to the heatsink through the transparent heatsink window, wherein the transparent heatsink window separates the first phosphor layer from the second phosphor layer, wherein the first phosphor layer has a first area, wherein the second phosphor layer has a second area, and wherein the second area is smaller than the first area.

Some embodiments of the third apparatus further include a heat-conductive wall coupled to the heatsink, wherein the heat-conductive wall surrounds a perimeter of the first LED light source and the first phosphor layer, wherein the heat-conductive wall is separated from the perimeter of the first LED light source and the first phosphor layer by a gap; and a transparent heatsink window, wherein the transparent heatsink window is coupled to the heat-conductive wall and the second phosphor layer such that heat from the second phosphor layer is conducted to the heatsink through the transparent heatsink window, wherein the transparent heatsink window is made of a material that includes aluminum oxynitride (AlON). In other embodiments, the transparent heatsink window is made of a material that includes diamond, sapphire and/or glass.

Some embodiments of the third apparatus further include a first heat-conductive wall coupled to the heatsink, wherein the first heat-conductive wall is separated by an offset distance from a first side of the first phosphor layer; and a cantilevered heatsink platform coupled to both the first heat-conductive wall and the second phosphor layer such that heat from the second phosphor layer flows through the cantilevered heatsink platform and the first heat-conductive wall to the heatsink, wherein the cantilevered heatsink platform is suspended and separated above the first phosphor layer.

Some embodiments of the third apparatus further include a first heat-conductive wall coupled to the heatsink, wherein the first heat-conductive wall is separated by an offset distance from a first side of the first phosphor layer; and a cantilevered heatsink platform coupled to both the first heat-conductive wall and the second phosphor layer such that heat from the second phosphor layer flows through the cantilevered heatsink platform and the first heat-conductive wall to the heatsink, wherein the cantilevered heatsink platform is suspended and separated above the first phosphor layer, wherein the first phosphor layer has a first area, wherein the second phosphor layer has a second area, and wherein the second area is smaller than the first area.

Some embodiments of the third apparatus further include a first heat-conductive wall coupled to the heatsink, wherein the first heat-conductive wall is separated by an offset distance from a first side of the first phosphor layer; and a cantilevered transparent heatsink coupled to both the first heat-conductive wall and the second phosphor layer such that heat from the second phosphor layer flows through the cantilevered transparent heatsink and the first heat-conductive wall to the heatsink, wherein the cantilevered transparent heatsink is suspended and separated above the first phosphor layer, wherein the first phosphor layer has a first area, wherein the second phosphor layer has a second area, and wherein the second area is smaller than the first area.

In some embodiments of the third apparatus, the first LED light source is one of a plurality of LED light sources, wherein each respective LED light source of the plurality of LED light sources includes a corresponding first phosphor layer affixed to the respective LED light source, wherein the second phosphor layer includes a reflective phosphor plate fused directly to at least a first one of the plurality of LED light sources.

In some embodiments of the third apparatus, the first LED light source is one of a plurality of LED light sources, wherein each respective LED light source of the plurality of LED light sources includes a corresponding first phosphor layer affixed to the respective LED light source, wherein the second phosphor layer is a reflective phosphor plate fused directly to at least a first one of the plurality of LED light sources, the light-source assembly further including: one or more lasers configured to optically pump the reflective phosphor plate, wherein the one or more lasers are supplied by an electric current; and a safety circuit integrated into the reflective phosphor plate and operatively coupled to the one or more lasers, wherein the safety circuit is configured to interrupt the electric current supplied to the one or more lasers when the reflective phosphor plate is broken.

In some embodiments, the present invention provides a fourth apparatus (such as illustrated in FIG. 13, 14, 15A, 15B, 16 or 17) that includes a hybrid light source for smart automotive-headlight applications, wherein the hybrid light source includes: a first light source of full-area illumination; a second light source that provides at least one beam of hot-spot illumination; a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions; and projection optics operatively coupled to receive light selectively reflected by the DMD and configured to project the received light as a beam having a shaped illumination intensity pattern.

Some embodiments of the fourth apparatus further include a controller operatively coupled to the DMD; a first light dump; and a second light dump, wherein the controller controls reflection directions of the plurality of micromirrors of the DMD such that light from the first light source is reflected to either the projection optics or the first light dump, and light from the second light source is reflected to either the projection optics or the second light dump.

Some embodiments of the fourth apparatus further include a vehicle, wherein the hybrid light source is mounted to the vehicle and controlled to provide smart headlight functions.

Some embodiments of the fourth apparatus further include a concave reflector, wherein the first light source of full-area illumination is projected onto the DMD by reflection from the concave reflector, and wherein the second light source of hot-spot illumination is projected onto the DMD through an aperture in the concave reflector.

In some embodiments of the fourth apparatus, the first light source of full-area illumination further includes: a light-emitting diode (LED) assembly; a lens operably coupled to receive light from the light-emitting diode (LED) assembly; a flat reflector operably coupled to receive light focused by the lens; and a concave reflector operably coupled to receive light reflected by the flat reflector, wherein light from the first light source of full-area illumination is projected onto the DMD by reflection from the concave reflector, and wherein the second light source of hot-spot illumination is projected onto the DMD through an aperture in the concave reflector.

In some embodiments of the fourth apparatus, the second light source of hot-spot illumination further includes: a phosphor plate; a blue-light laser that generates a blue-light laser beam that is focused onto the phosphor plate, wherein a portion of the blue-light laser beam is wavelength converted to yellow light; and collimating optics operably coupled to receive the wavelength-converted yellow light and an unconverted portion of the blue-light laser beam and configured to output collimated light as the beam of hot-spot illumination.

In some embodiments of the fourth apparatus, the second light source of hot-spot illumination further includes: a phosphor plate; a focusing lens; a blue-light laser that generates a blue-light laser beam that is focused by the focusing lens onto the phosphor plate, wherein a first portion of the blue-light laser beam is wavelength converted to yellow light and a second portion of the blue-light laser beam is unconverted and transmitted through the phosphor plate; and collimating optics operably coupled to receive the wavelength-converted yellow light and the unconverted portion of the blue-light laser beam and configured to output collimated light as the beam of hot-spot illumination.

In some embodiments, the present invention provides a fifth apparatus (such as illustrated in FIG. 3, 4, 5, 6 or 7) that includes a heat sink; a blue LED mounted on the heat sink, wherein the blue LED emits blue light; a phosphor structure that has a first face and a second face opposite the first face mounted such that the blue light from the LED propagated into the phosphor structure through the first face of the phosphor structure; and a laser arranged to emit laser light that has a primary laser-light wavelength into the phosphor structure through the second face of the phosphor structure.

Some embodiments of the fifth apparatus further include: a collimating optics structure configured to receive light from the phosphor structure and to collimate the light from the phosphor structure into a collimated beam having a collimated beam axis and a collimated beam direction; a reflector filter configured to selectively reflect at least light of the primary laser-light wavelength and positioned to reflect the laser light along the collimated beam axis in a direction opposite the collimated beam direction through the collimating lens structure toward a center of the phosphor structure. Some such embodiments further include a coupling lens structure configured to receive light from the phosphor structure and to collimate the light from the phosphor structure into a collimated beam having a collimated beam axis and a collimated beam direction; and a digital micromirror device (DMD) located and configured to reflect light from the collimated beam. Some such embodiments further include a projection lens assembly; and a total-internal-reflection (TIR) prism configured to receive the collimated beam and direct a resulting beam onto the DMD and to receive light reflected from the DMD and direct a resulting beam toward the projection lens assembly.

Some embodiments of the fifth apparatus further include a vehicle, wherein the hybrid light source is mounted to the vehicle and controlled to provide smart headlight functions.

Some embodiments of the fifth apparatus further include an enclosure window, wherein the heatsink forms a hollow enclosure that has the enclosure window sealed to a light-exit end of the hollow enclosure, and wherein the blue LED and the laser are mounted substantially inside of the hollow enclosure.

In some embodiments, the present invention provides a sixth apparatus (such as illustrated in FIG. 16) that includes a dual light source for smart automotive-headlight applications, The dual light source includes: a digital micromirror device (DMD) having a plurality of micromirrors; a full-area light source imparting light upon the DMD at a first angle from a first side of the DMD, wherein the first angle is relative to a normal-angle line to a major surface of the DMD, and a hot-spot light source imparting light upon the DMD at a second angle from a second side of the DMD, wherein the second angle is relative to the normal-angle line to the major surface of the DMD on an opposite side to the first angle; a first-side light dump located at a third angle that is larger than the first angle on the first side of the DMD; a second-side light dump located at a fourth angle that is larger than the second angle on the second side of the DMD, and output optics located along the normal-angle line to the major surface of the DMD, wherein when a first selected one of the plurality of micromirrors is positioned to direct light from the full-area light source towards the output optics, the first selected one of the plurality of micromirrors directs light from the hot-spot light source towards the first-side light dump. In some such embodiments, when a second selected one of the plurality of micromirrors is positioned to direct light from the hot-spot light source towards the output optics, the second selected one of the plurality of micromirrors directs light from the full-area light source towards the second-side light dump.

In some embodiments, the present invention provides a seventh apparatus (such as illustrated in FIG. 8F) that includes a hybrid light source for smart automotive-headlight applications, wherein the hybrid light source includes: a heatsink; a blue LED mounted on the heat sink, wherein the blue LED emits blue light; a first phosphor structure that has a first face and a second face opposite the first face mounted such that the blue light from the LED propagated into the phosphor structure through the first face of the first phosphor structure and wavelength-converted yellow light and an unconverted portion of blue light from the LED are propagated out of the second face of the first phosphor structure; and a second phosphor structure that has a first face and a second face opposite the first face, wherein the first face is mounted on the heatsink such that blue light from a laser is propagated into the phosphor structure through the second face of the second phosphor structure and wavelength-converted yellow light and an unconverted portion of blue light from the laser are propagated out of the second face of the second phosphor structure.

Some embodiments of the seventh apparatus further include a laser arranged to emit laser light that has a blue laser-light wavelength into the second phosphor structure through the second face of the second phosphor structure. Some such embodiments further include a safety circuit that automatically turns the laser off if the second phosphor structure breaks. In some such embodiments, the second phosphor structure is a crystal phosphor plate and wherein the safety circuit includes an electrically conductive trace on the crystal phosphor plate.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1.-3. (canceled)

4. An apparatus comprising:
a hybrid light source for smart automotive-headlight applications, wherein the hybrid light source includes:
a light-emitting diode (LED) light source of full-area illumination;
a laser-pumped phosphor material that provides one or more areas of hot-spot illumination;
a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions;
projection optics operatively coupled to receive light selectively reflected by the DMD and configured to project the received light as a beam having a shaped illumination intensity pattern;
wherein the LED source further includes:
a first heatsink,
a blue-emitting LED, mounted to the first heatsink, wherein the blue-emitting LED outputs blue-LED pump light having LED pump wavelengths, and
a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and
wherein the laser-pumped phosphor material is a crystal-phosphor plate that is mounted in contact with the first phosphor layer and that covers at least a portion of a surface of the first phosphor layer.

5. The apparatus of claim 4,
wherein the laser-pumped phosphor material covers less than 50% of a surface of the first phosphor layer.

6. An apparatus comprising:
a hybrid light source for smart automotive-headlight applications, wherein the hybrid light source includes:
a light-emitting diode (LED) light source of full-area illumination;
a laser-pumped phosphor material that provides one or more areas of hot-spot illumination;
a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions;
projection optics operatively coupled to receive light selectively reflected by the DMD and configured to project the received light as a beam having a shaped illumination intensity pattern;
wherein the LED source further includes:
a first heatsink;
a blue-emitting LED, mounted to the first heatsink, wherein the blue-emitting LED outputs blue-LED pump light having LED pump wavelengths; and
a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and
wherein the laser-pumped phosphor material is a crystal-phosphor plate that is mounted to a thermally conductive structure that is in contact with the first heatsink but separated from the blue-emitting LED and the first phosphor layer by a gap, and wherein the crystal-phosphor plate covers an entirety of a surface of the first phosphor layer.

7. An apparatus comprising:
a hybrid light source for smart automotive-headlight applications, wherein the hybrid light source includes:
a light-emitting diode (LED) light source of full-area illumination;
a laser-pumped phosphor material that provides one or more areas of hot-spot illumination;
a digital micromirror device (DMD) operatively coupled to receive light from the full-area illumination and the hot-spot illumination, wherein the DMD includes a plurality of micromirrors, wherein each of the plurality of micromirrors of the DMD is configured to selectively reflect light in one of a plurality of directions;
projection optics operatively coupled to receive light selectively reflected by the DMD and configured to project the received light as a beam having a shaped illumination intensity pattern;
wherein the LED source further includes:
a first heatsink;
a blue-emitting LED, mounted to the heatsink, wherein the blue-emitting LED outputs blue-LED pump light having LED pump wavelengths; and
a first phosphor layer located on the blue-emitting LED and operatively coupled to receive the blue-LED pump light and wavelength-convert a portion of the blue-LED pump light to wavelength-converted LED light having longer wavelengths than the LED pump wavelengths; and
wherein the laser-pumped phosphor material is a crystal-phosphor plate that is mounted to a thermally conductive structure that is in contact with the first heatsink but separated from the blue-emitting LED and the first phosphor layer by a gap, and wherein the crystal-phosphor plate covers less than 50% of a surface of the first phosphor layer.

8. The apparatus of claim 4, wherein the projection optics further includes:
coupling optics operatively coupled to receive light from the LED light source and the laser-pumped phosphor material;
a total-internal-reflection (TIR) prism assembly operatively coupled to receive light transferred from the coupling optics; and
a projection-lens assembly operatively coupled to receive light redirected by the TIR prism assembly and to project a headlight beam based on the received light from the TIR prism assembly.

9. The apparatus of claim 4, further comprising:
a controller operatively coupled to the DMD and configured to selectively control the plurality of micromirrors of the DMD to adjust the shaped illumination intensity pattern for a vehicle headlight low beam and high beam.

10. The apparatus of claim 9, further comprising a vehicle, wherein the hybrid light source is mounted to the vehicle and controlled to provide smart headlight functions.

11.-45. (canceled)

46. The apparatus of claim 4, further comprising:
a pump laser that outputs a laser beam having a pump-laser wavelength, wherein the laser-pumped phosphor material is a crystal-phosphor plate operatively coupled to receive the laser beam and configured to wavelength-convert a portion of the laser-beam pump light to wavelength-converted laser light having longer wavelengths than the pump-laser wavelength.

47. The apparatus of claim 6, wherein the projection optics further includes:
coupling optics operatively coupled to receive light from the LED light source and the laser-pumped phosphor material;
a total-internal-reflection (TIR) prism assembly operatively coupled to receive light transferred from the coupling optics; and
a projection-lens assembly operatively coupled to receive light redirected by the TIR prism assembly and to project a headlight beam based on the received light from the TIR prism assembly.

48. The apparatus of claim 6, further comprising:
a controller operatively coupled to the DMD and configured to selectively control the plurality of micromirrors of the DMD to adjust the shaped illumination intensity pattern for a vehicle headlight low beam and high beam.

49. The apparatus of claim 6, further comprising:
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

50. The apparatus of claim 6, further comprising:
coupling optics operatively coupled to receive light from the LED light source and the laser-pumped phosphor material;
a total-internal-reflection (TIR) prism assembly operatively coupled to receive light transferred from the coupling optics, wherein the projection optics is operatively coupled to receive light redirected by the TIR prism assembly and to project a headlight beam based on the received light from the TIR prism assembly;
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

51. The apparatus of claim 6, further comprising:
a laser that provides excitation light to the laser-pumped phosphor material;
coupling optics operatively coupled to receive light from the LED light source and the laser-pumped phosphor material;
a total-internal-reflection (TIR) prism assembly operatively coupled to receive light transferred from the coupling optics, wherein the projection optics is operatively coupled to receive light redirected by the TIR prism assembly and to project a headlight beam based on the received light from the TIR prism assembly;
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

52. The apparatus of claim 6, further comprising:
a pump laser that outputs a laser beam having a pump-laser wavelength, wherein the laser-pumped phosphor material is a crystal-phosphor plate operatively coupled to receive the laser beam and configured to wavelength-convert a portion of the laser-beam pump light to wavelength-converted laser light having longer wavelengths than the pump-laser wavelength.

53. The apparatus of claim 7, wherein the projection optics further includes:
coupling optics operatively coupled to receive light from the LED light source and the laser-pumped phosphor material;
a total-internal-reflection (TIR) prism assembly operatively coupled to receive light transferred from the coupling optics; and
a projection-lens assembly operatively coupled to receive light redirected by the TIR prism assembly and to project a headlight beam based on the received light from the TIR prism assembly.

54. The apparatus of claim 7, further comprising:
a controller operatively coupled to the DMD and configured to selectively control the plurality of micromirrors of the DMD to adjust the shaped illumination intensity pattern for a vehicle headlight low beam and high beam.

55. The apparatus of claim 7, further comprising:
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

56. The apparatus of claim 7, further comprising:
coupling optics operatively coupled to receive light from the LED light source and the laser-pumped phosphor material;
a total-internal-reflection (TIR) prism assembly operatively coupled to receive light transferred from the coupling optics, wherein the projection optics is operatively coupled to receive light redirected by the TIR prism assembly and to project a headlight beam based on the received light from the TIR prism assembly;
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

57. The apparatus of claim 7, further comprising:
a laser that provides excitation light to the laser-pumped phosphor material;
coupling optics operatively coupled to receive light from the LED light source and the laser-pumped phosphor material;
a total-internal-reflection (TIR) prism assembly operatively coupled to receive light transferred from the coupling optics, wherein the projection optics is operatively coupled to receive light redirected by the TIR prism assembly and to project a headlight beam based on the received light from the TIR prism assembly;
a controller operatively coupled to the DMD and configured to selectively control the plurality of micromirrors of the DMD to adjust the shaped illumination intensity pattern for a vehicle headlight low beam and high beam; and
a vehicle, wherein the hybrid light source is mounted to the vehicle and controlled to provide smart headlight functions.

58. The apparatus of claim 7, further comprising:
a pump laser that outputs a laser beam having a pump-laser wavelength, wherein the laser-pumped phosphor material is a crystal-phosphor plate operatively coupled to receive the laser beam and configured to wavelength-convert a portion of the laser-beam pump light to wavelength-converted laser light having longer wavelengths than the pump-laser wavelength.
